(19) United States
(12) Patent Application Publication
(10) Pub. No.: US 2013/0205223 A1
(43) Pub. Date: Aug. 8, 2013

(54) SYSTEMS AND METHODS FOR CUSTOMIZED MUSIC SELECTION AND DISTRIBUTION

(71) Applicant: Benjamin Shaffer Gilbert, Jackson Heights, NY (US)

(72) Inventor: Benjamin Shaffer Gilbert, Jackson Heights, NY (US)

(73) Assignee: ISHLAB INC., Brooklyn, NY (US)

(21) Appl. No.: 13/879,117

(22) PCT Filed: Oct. 14, 2011
(86) PCT No.: PCT/US11/56486

§ 371 Date: Apr. 12, 2013

Related U.S. Application Data
(60) Provisional application No. 61/393,054, filed on Oct. 14, 2010.

(51) Int. Cl. H04L 29/08

(52) U.S. Cl. CPC H04L 67/02
USPC 715/748

(57) ABSTRACT

Systems and methods for the customized selection and distribution of digital music are described herein. In one embodiment, a method of selecting and delivering music to a user includes creating an annotated record of one or more digital music tracks by performing a waveform analysis to determine characteristics of the one or more digital music tracks, associating a plurality of global music factors with the one or more digital music tracks, and associating a plurality of population music factors with the one or more digital music tracks. The method further includes receiving one or more user characteristics, selecting one or more digital music tracks for delivery by matching the one or more user characteristics against information in the annotated record of the one or more digital music tracks, and delivering the one or more digital music tracks to the user.

### RELATED APPLICATIONS

This application claims priority to U.S. Provisional Application No. 61/393,054, filed on Oct. 14, 2010. This application also claims priority to U.S. Provisional Application No. 61/______, entitled “Ishlab Methods and Processes,” filed on Feb. 23, 2011. The contents of these related applications are herein incorporated by reference in their entirety.

### FIELD

This invention relates to digital music selection and distribution and, in particular, to systems and methods for collecting digital music and delivering customized music selections based on any number of data factors related to a particular song and an intended audience.

### BACKGROUND

Locating and selecting music that a particular user will like is frequently a challenging task. Recent technological developments have resulted in an increasing amount of digital distribution of music to both commercial and consumer users. However, the increasing amount of available content and the increasing number of sources for that content has not necessarily reduced, and in some cases has added to, the difficulty users encounter in finding music they like. Similarly, while some artists have benefitted tremendously from being able to distribute their music digitally, many are unable to effectively distribute their music to audiences that are interested, or would be interested, in hearing it. These problems can be attributed to, among other things, insufficient tools for searching the large catalogs of music available for digital distribution today.

Accordingly, there is a need for improved systems and methods for connecting an artist or song with a user who has, or is likely to have, an interest in the song. In particular, there is a need for more efficient systems and methods for collecting music, licensing it for distribution, and selectively distributing it to users most likely to find it desirable.

### SUMMARY

To overcome the above and other drawbacks of conventional systems, the present invention provides systems and methods for collecting and/or cataloging music, clearing its authorization for distribution to one or more users, analyzing the music to create a rich description of the music, and selecting particular music for delivery to a user based on a variety of data factors associated with both the music, the user requesting the music, and other similar (and dissimilar) users. The systems and methods of the present invention provide value to content providers and consumers by more efficiently licensing the music from the providers for distribution to the consumers, and connecting particular music (and thereby particular providers) with consumers who are most likely to enjoy the music.

In one aspect of the invention, a method of selecting and delivering music to a user is provided including creating an annotated record of one or more digital music tracks by performing a waveform analysis on the one or more digital music tracks to determine characteristics of the one or more digital music tracks, associating a plurality of global music factors with the one or more digital music tracks, and associating a plurality of population music factors with the one or more digital music tracks. The method further includes receiving, from a user, one or more user characteristics, and selecting one or more digital music tracks for delivery to the user by matching the one or more user characteristics against information contained in the annotated record of the one or more digital music tracks. The method also includes delivering the one or more digital music tracks to the user.

The waveform music analysis can identify characteristics of the one or more digital music tracks by examining the waveform of the digital music track. In some embodiments, the characteristics of the one or more digital music tracks determined by the waveform analysis include any of song tempo, song key, song era, song feel, song mood, vocal type, instrumentation, and playing style. The waveform analysis can provide a record of the characteristics determined during the analysis in a variety of forms (e.g., database records, text files, etc.).

The plurality of global music factors associated with a digital music track can include any of music sales information, listener demographic information, listener psychographic information, listener sociographic information, listener sentiment, listener location, song genre, song artist, song name, song date, song era, song artist label, song lyrics, and song length. The global music factors can be derived from data obtained from external sources, such as reviewer websites, industry publications on music sales, etc.

The plurality of population music factors can include any of listener demographic information, listener psychographic information, listener sociographic information, song popularity, song popularity within specific social profiles and/or sociographic groups and/or demographic groups and/or psychographic groups, listener habitation history, listener address, listener city, listener state, listener postal code, listener education, listener social profile, listener feedback rating, listener preference data, time of day for song performance, and type of event or purpose for song performance. Population music factors, as opposed to global music factors, can be derived from data obtained from internal sources, such as other users of the systems and methods of the present invention.

The one or more user characteristics can include any of song artist, similar artist, favorite artists, song name, similar song, song genre, location and/or purpose for song performance, time of day for song performance, song tempo, song mood, song feel, song and/or band geography, song instrument, song popularity, song era, song playlist, playlist author, user preference data, as well as user sociographic data and/or user psychographic data and/or user demographic data. User characteristics can be received by a user as a direct request for music of a certain artist or type, or can be general preference data collected from a user regarding the user's tastes in music, demographic information, etc.

The method can include a variety of additional steps or modifications. In some embodiments, the method can further include receiving one or more digital music tracks via upload from a remote source and applying a rights clearance process to ensure that the one or more digital music tracks are approved for license and delivery to one or more users. In certain embodiments, the rights clearance process can further include receiving a listing of one or more rights holder and/or rights holder representatives in a digital music track, and electronically notifying each of the one or more rights holders and/or rights holder representatives that the digital music track has been submitted for delivery to one or more users. The rights clearance process can further include electronically receiving approval from each of the one or more rights holders and/or rights holder representatives to deliver the digital music track to one or more users prior to delivering the digital music track to the user. In certain embodiments, each of the one or more rights holders and/or rights holder representatives can be electronically notified via any of an email message and a notification on a website. In certain other embodiments, approval from each of the one or more rights holders and/or rights holder representatives can be electronically received via a website.

In some embodiments, selecting one or more digital music tracks for delivering to the user can include receiving a listing of one or more digital music tracks selected by a disc jockey (DJ). In such embodiments, the DJ can use the systems and methods of the present invention to filter selections provided by matching one or more user characteristics against information contained in the annotated record of the one or more digital music tracks. In certain other embodiments, selecting one or more digital music tracks for delivery to the user includes receiving, prior to receiving the listing of one or more digital music tracks selected by the DJ, one or more weighted search parameters based on any of the information in the annotated record of the digital music tracks and the one or more user characteristics received from the user. These weighted search parameters can be used to provide the DJ with a selection of digital music tracks based on matching between the one or more weighted search parameters and the information in the annotated record of the digital music tracks. The DJ can then filter these selections to provide the listing of one or more digital music tracks selected by the DJ.

In other embodiments, selecting the one or more digital music tracks for delivery to the user can include executing an algorithm to automatically select the one or more digital music tracks based on a degree of matching between the user characteristics and the information in the annotated record. In some embodiments, the algorithm can be configured to assign a weighting factor to each of the user characteristics utilized in selecting the one or more digital music tracks for delivery to the user. These weighting factors can be determined based on, for example, user preference data or requests for particular types of music, moods, etc. The weighting factors can be utilized, for example, in ranking tracks that match based on a plurality of user characteristics.

In still other embodiments, the method can further include receiving, from a user, one or more feedback indications based on the one or more digital music tracks delivered to the user, and incorporating the one or more feedback indications into any of the plurality of population music factors and the one or more user characteristics. By doing so, the systems and methods of the present invention can utilize the user's feedback in making future selections of digital music tracks to deliver to the user, as well as other users that are similar—or dissimilar—to the user.

In some embodiments, the method can further include associating any of the plurality of global music factors and population music factors of a first digital music track with a second digital music track where the second digital music track has no available global music factors or population music factors and where the waveform analysis indicates that the first digital music track and the second digital music track share a plurality of characteristics. Making this association between tracks that share a plurality of characteristics can allow more accurate predictions regarding the types of users and audiences that appreciate the second digital music track.

In a second aspect of the invention, a system for selecting and delivering music to a user is provided, including a digital data processor configured to create an annotated record of one or more digital music tracks by performing a song waveform analysis to determine characteristics of the one or more digital music tracks, associating a plurality of global music factors with the one or more digital music tracks, and associated a plurality of population music factors with the one or more digital music tracks. The system further includes a user interface configured to received, from a user one or more user characteristics. The system also includes a digital data processor configured to select one or more digital music tracks for delivery to the user by matching the one or more characteristics against information contained in the annotated record of the one or more digital music tracks.

As described above, the characteristics of the one or more digital music tracks determined by the waveform analysis can include any of song tempo, song key, song era, song feel, song mood, vocal type, instrumentation, and playing style. Similarly, the plurality of global music factors associated with a digital music track can include any of music sales information, listener demographic information, listener psychographic information, listener sociographic information, listener sentiment, listener location, song genre, song artist, song name, song date, song era, song artist label, song lyrics, and song length. In addition, the plurality of population music factors can include any of listener demographic information, listener psychographic information, listener sociographic information, song popularity, song popularity within specific social profiles and/or sociographic groups and/or demographic groups and/or psychographic groups, listener habitation history, listener address, listener city, listener state, listener postal code, listener education, listener social profile, listener feedback rating, listener preference data, time of day for song performance, and type of event or purpose for song performance. The one or more user characteristics can include any of song artist, similar artist, favorite artists, song name, similar song, song genre, location and/or purpose for song performance, time of day for song performance, song tempo, song mood, song feel, song and/or band geography, song instrument, song popularity, song era, song playlist, playlist author, user preference data, as well as user sociographic data and/or user psychographic data and/or user demographic data. User characteristics can be received by a user as a direct request for music of a certain artist or type, or can be general preference data collected from a user regarding the user's tastes in music, demographic information, etc.

In some embodiments, the system can include a memory store configured to receive one or more digital music tracks from remote sources and a digital data processor configured to perform a rights clearance process to ensure that the one or more digital music tracks in the memory store are approved for delivery to one or more users. In certain embodiments, the digital data processor configured to perform the rights clearing process is further configured to receive a listing of one or more rights holders and/or rights holder representatives in a digital music track, and electronically notify each of the one of more rights holders and/or rights holder representatives that the digital music track has been submitted for delivery to one or more users. The digital data processor can be further configured to electronically receive approval from each of the one or more rights holders and/or rights holder representatives to deliver the digital music track to one or more users prior to delivering the digital music track to the one or more users.

In certain other embodiments, the digital data processor configured to select one or more digital music tracks from the memory store for delivery to the user can include an interface configured to receive a listing of one or more digital music tracks from a disc jockey (DJ). The DJ can, for example, filter a selection of tracks created by the system by matching one or more user characteristics against information in the annotated record of one or more digital music tracks.

In other embodiments, the digital data processor configured to select one or more digital music tracks from the memory store for delivery to the user can be further configured to execute an algorithm to automatically select the one or more digital music tracks. The algorithm can, for example, select the tracks based on matching between the one or more user characteristics and the information in the annotated record of the one or more digital music tracks. In some embodiments, the algorithm can be configured to assign a weighting factor to each of the user characteristics utilized in selecting the one or more digital music tracks. The weighting factors can be utilized by the algorithm to, for example, choose among digital music tracks that match on different user characteristics.

In some embodiments, the system can further include a user interface configured to deliver the one or more selected digital music tracks to the user via network streaming and to receive from the user one or more feedback indications based on the one or more digital music tracks. The user interface can include one or more controls to allow the user to adjust the playback of the digital music tracks and to submit the one or more feedback indications regarding the digital music tracks.

In a third aspect of the invention, a system for selecting and delivering music to a user is provided, including a digital data processor configured to create an annotated record of one or more digital music tracks by performing a waveform analysis to determine characteristics of the one or more digital music tracks, associating a plurality of global music factors with one or more digital music tracks, and associated a plurality of population music factors with the one or more digital music tracks. The system further includes a first user interface configured to receive, from a user, one or more user characteristics, as well as a second user interface configured to provide one or more search mechanisms to allow a disc jockey (DJ) to search and select one or more digital music tracks based on any of the information in the annotated record of the one or more digital music tracks and the one or more user characteristics received from the user. The system also includes a third user interface configured to provide one or more ordering mechanisms to allow a DJ to create and organize one or more playlists containing the one or more digital music tracks selected in the second user interface based on any of the information in the annotated records the one or more digital music tracks, the one or more characteristics received from the user, and one or more music flow characteristics. The system can further include a fourth user interface configured to deliver the one or more digital music tracks selected by the DJ to the user and collect from the user one or more feedback indications based on the one or more digital music tracks delivered to the user.

The music flow characteristics can include any of time of day, day of the week, mood, vocals, genre, tempo, era, and instrumentation. Music flow characteristics can be used by the system to ensure that music played during a certain time period comports with a user's expectations and/or desires for the type of music at the particular time.

In some embodiments, the system can further include a fifth user interface configured to receive one or more digital music tracks via network upload as well as electronic certifications of authorization from one or more rights holder and/or rights holder representatives to distribute the one or more digital music tracks to one or more users. The system can also include a memory store in communication with the fifth user interface to store the one or more digital music tracks received via network upload.

In other embodiments, the system can further include a digital data processor configured to automatically create a duplicate playlist based on an original playlist created in the third user interface by selecting one or more digital music tracks having similar characteristics to the one or more digital music tracks in the original playlist, where the duplicate playlist and the original playlist do not contain the same digital music tracks.

In certain embodiments, the system can further include a digital data processor configured to randomize a playlist created in the third user interface by grouping one or more digital music tracks of the playlist into a plurality of chunks of a desired number of tracks and randomly ordering the digital music tracks within each of the plurality of chunks, where the order of the plurality of chunks is preserved and where the desired number of tracks is greater than one and less than the total number of tracks in the playlist.

### BRIEF DESCRIPTION OF THE DRAWINGS

The invention will be more fully understood from the following detailed description taken in conjunction with the accompanying drawings, in which:

FIG. 1 is a diagram illustrating an embodiment of a system of the invention;

FIG. 2 is a diagram illustrating an embodiment of a user registration process of the invention;

FIG. 3 is a diagram illustrating an embodiment of an upload process of the invention;

FIG. 4 is a table illustrating exemplary descriptive data that can be associated with a digital music track

FIG. 5 is a table illustrating exemplary data that can be collected during an upload process of the invention;

FIG. 6 is diagram of an embodiment of a rights clearing process of the invention;

FIG. 7 is a diagram illustrating an embodiment of the analysis component of the system depicted in FIG. 1;

FIG. 8 is a listing of exemplary themes, moods, and feels that can be associated with a digital music track;

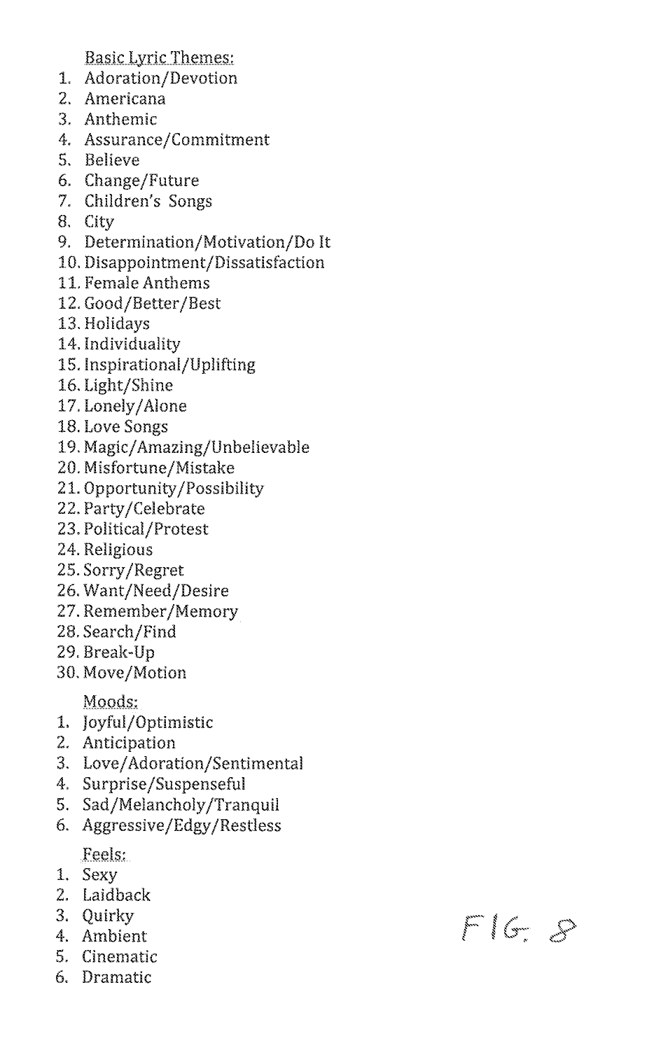

FIG. 9 is a table illustrating exemplary consumer music sales information that can be utilized by the systems and methods of the present invention;

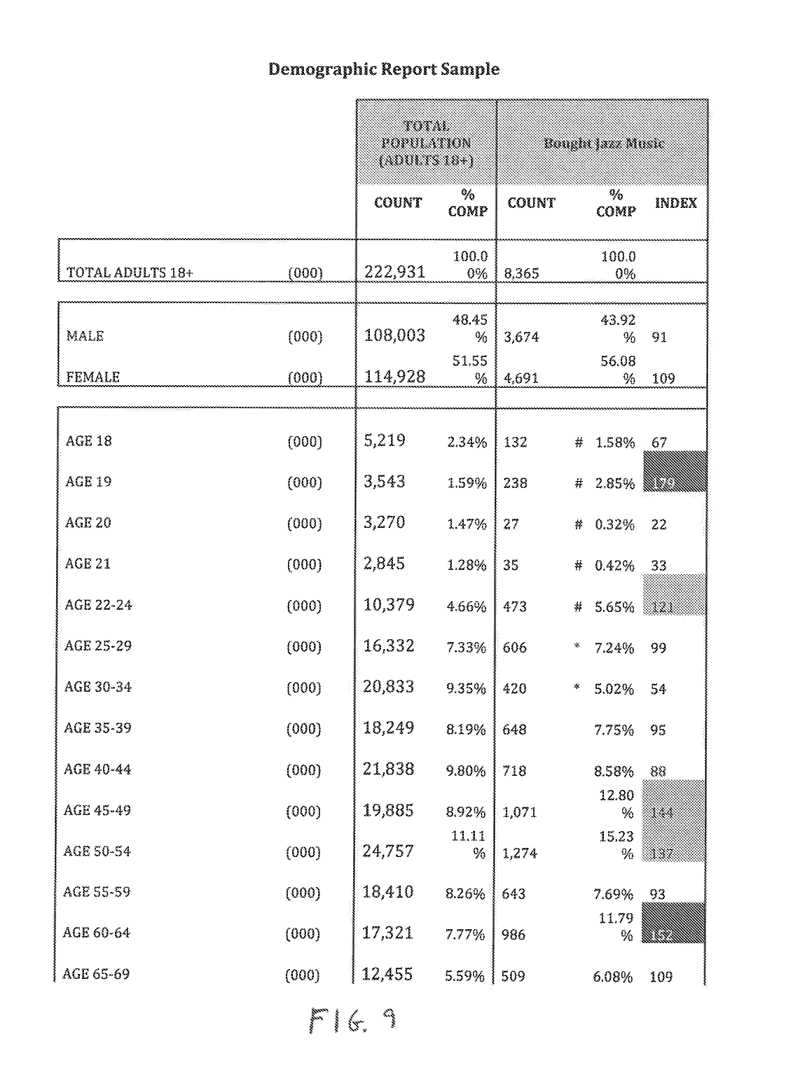

FIG. 10 is a diagram of an embodiment of a music licensing search process of the invention;

FIG. 11 is an illustration of an embodiment of a music licensing search interface of the invention;

FIG. 12 is an illustration of an embodiment of a music licensing pitch interface of the invention;

FIG. 13 is a diagram of an embodiment of a music styling search and playlist creation process of the invention;

FIG. 14 is an illustration of an embodiment of a music styling search interface of the invention;

FIG. 15 is an illustration of an embodiment of a music styling playlist flow interface of the invention;

FIG. 16 is a diagram of an embodiment of an automated music search and selection process of the invention;

FIG. 17 is a diagram of a delivery component of the system depicted in FIG. 1;

FIG. 18 is an illustration of an embodiment of a player interface of the present invention;

FIG. 19 is an illustration of an alternate embodiment of the player interface of FIG. 18;

FIG. 20 is a diagram of an exemplary user interaction with a system of the invention; and

FIG. 21 is a diagram illustrating an overview of exemplary user types and associated primary interactions with a system of the invention.

### DETAILED DESCRIPTION

Certain exemplary embodiments will now be described to provide an overall understanding of the principles of the systems and methods disclosed herein. One or more examples of these embodiments are illustrated in the accompanying drawings. Those skilled in the art will understand that the systems and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

The present invention provides novel systems and methods for the targeted distribution of music based on data related to the music itself, the audience receiving the music, and the context for the music performance. In order to deliver targeted music selections, the systems and methods of the present invention analyze each digital music track to create and acquire as much information as possible about the track's inherent characteristics (e.g., genre, instrumentation, vocal type, mood, etc.). This inherent information is combined with external information about the global audience for the music (e.g., who listens to the music, what is the social profile of listeners, what else do they like or dislike, how commercially successful is the song, etc.). Finally, this external information is combined with data collected from the population of system users (e.g., specifically defined listening preferences, user-defined demographic, psychographic, and sociographic information, passively defined listening preferences such as song skips, etc.). When combined, all of this data forms an annotated record of digital music that is richly descriptive and can be searched or sorted according to any number of the data types contained in the record. This enables the systems and methods of the present invention to provide intelligent music selections that a user is likely to enjoy or find appropriate for a given purpose. Systems and methods of the present invention can make these selections automatically and/or based on defined user preferences and/or criteria for the music.

In addition, the systems and methods of the present invention collect feedback and usage data from users as they listen to the music selected for them. Collecting this feedback allows the systems and methods of the present invention to continually update the information in the annotated record associated with each digital music track and make more intelligent future decisions regarding a particular user's taste, as well as other users' similar—and dissimilar—tastes.

Systems and methods of the present invention also provide advantages over prior art music distribution systems by providing for direct submission of new music from artists, along with efficient electronic licensing and rights clearance, and automatic royalty payment processing. The end result is that the systems and methods of the present invention can provide a more direct path from an artist to a user (commercial or consumer) than is currently possible by efficiently clearing the music for distribution and subsequently delivering the music to audiences that are most likely to desire it. The systems and methods of the present invention are particularly adept at providing rights clearance for digital music tracks having a plurality of rights holders, as prior art techniques for obtaining authorization from a plurality of rights holders can be awkward and time consuming.

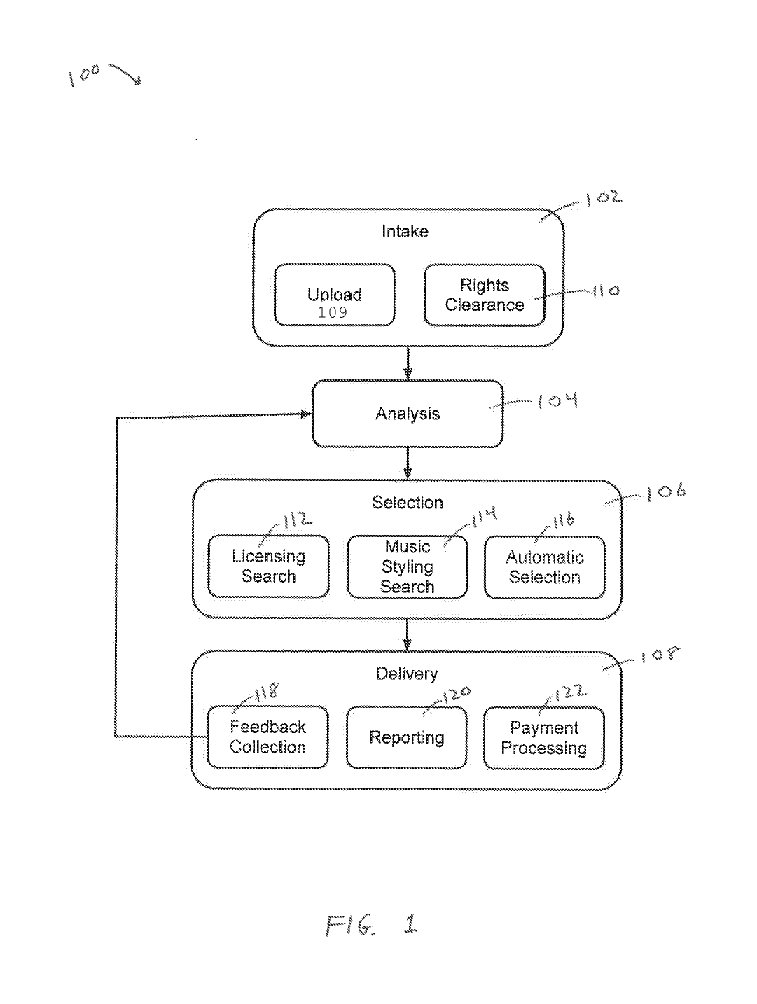

In one aspect of the invention, a system for the collection, selection, and distribution of digital music is provided. The system can include one or more sub-systems devoted to particular aspects of music collection, selection, and distribution. FIG. 1 illustrates the various components of the overall system 100. For example, the process of selecting and distributing one or more digital music tracks can begin with the intake system 102, where one or more digital music tracks can be added to the system 100 for subsequent delivery to one or more users. The intake system 100 can include an upload process 109, broadly defined as processes to catalog music located remotely, such as in another content provider's music repository, or to accept direct uploads to a repository connected to the system 100. In addition, the intake system 100 can execute a licensing or rights clearance process 110 to ensure that the digital music tracks added to the system are authorized for licensing and distribution to one or more users. The system 100 can also include an analysis component 104 that can perform one or more analyses on the digital music tracks in the system 100 (including any tracks previously added to the system and any new tracks submitted through the intake component 102) to extract data from the tracks or associate data with the tracks. The data extracted from, and associated with, the digital music tracks can be used to create an annotated record, such as a database or other information store, of the digital music tracks in the system 100. A selection component 106 of the system 100 can provide interfaces and functionality to select one or more digital music tracks from the system 100 for delivery to one or more users based on the comprehensive and descriptive information in the annotated record. The selection component can provide a number of interfaces and/or components and search and/or selection tools based on the type of user. These can include, for example, a music licensing search interface 112 for users interested in licensing music for media sync applications, a music styling search and playlist creation interface 114 for users providing music styling to, for example, retail stores, as well as an automated selection interface 116 for users who may or may not want to manually search for music. Selected digital music tracks can be delivered to one or more users through a delivery component 108 of the system 100. The delivery component can provide one or more interfaces and/or components for delivering selected digital music tracks to a user, such as a web-based music streaming interface. The delivery component 108 can include feedback collection component 118 to collect feedback from users as they listen to digital music tracks, and the feedback can then be incorporated into the annotated record of the digital music tracks to improve future music selections and/or searches. The delivery component 108 can also include reporting component 120 to provide automated reporting of the digital music tracks delivered to a user. This reporting can be submitted to rights holders, other interested parties, performance rights organizations, and more. Further, the delivery component 108 can include payment processing component 122 to automate royalty payment processing based on the tracks delivered by the system 100. The delivery component 108 can also provide automated electronic notifications and license processing to content rights holders and users, if necessary, once a particular digital music track has been selected for a particular use.

It should be appreciated that the system 100 can include any combination of the components 102, 104, 106, and 108 discussed above. Each of these components can be operated integrally to system 100, or can be implemented as a stand-alone system configured to accept inputs, perform the function described herein, and produce appropriate outputs. Modifications of the system 100 illustrated in FIG. 1 including, for example, the absence of an intake process when a catalog of digital music tracks is preexisting, or the rearrangement of certain components, is intended to be within the scope of the present invention.

Each of the components introduced above is discussed in turn below:

Intake

The system 100 is capable of accepting digital music tracks from a variety of sources. For example, the system 100 can be implemented with a dedicated digital memory store, such as a computer hard drive or a networked system of hard drives, configured to accept digital music tracks and store them for future distribution. Digital music tracks can be added to the digital memory store via direct network upload from a user, via physical connection to the hard drive(s), or via networked transfer from another location.

Alternatively, the intake component 102 can be configured to access a remote source, such as a third party's digital memory store, to add digital music files to the system 100 without actually copying the files to a dedicated digital memory store of the system 100. The remote source can be accessed, for example, using a network connection between the system 100 and the remote source. In such an embodiment, the intake components 102, and analysis component 104, can be configured to access the digital music tracks at the remote source in order to conduct analyses and create an annotated record. The annotated record itself, which can be embodied as a database or other information store, can also reside on either a dedicated digital memory store associated with the system 100, or can reside on a remote digital memory store. Still further, the delivery component 108 can be configured to deliver music to users directly from the remote source. This allows the system to be used effectively with large third party content libraries without having to duplicate the library of digital music tracks.

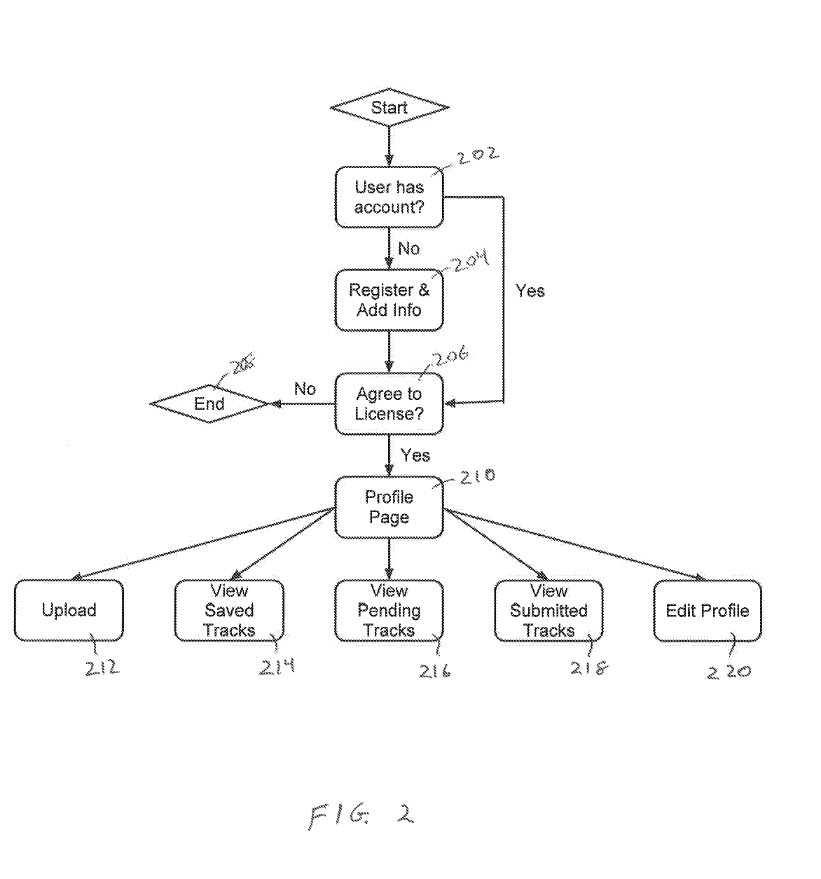

The system 100 can accept registrations form one or more users who wish to submit tracks for distribution. FIG. 2 illustrates one embodiment of a user registration workflow for a user who wishes to submit content to the system 100. First, the system 100 determines if the user has an account already 202. If so, not the user is required to fill out a registration form 204 that can collect information about the user such as name, address, email, bands represented (if applicable), etc. If the user already has an account, this step can be bypassed. Next, a user is asked to submit to a licensing agreement 206 between the system operator, any other interested parties, and the user. If the user chooses not to accept the licensing agreement, the process of registering to submit digital music tracks to the system 100 can be terminated. After the licensing agreement is accepted, the user can be brought to a profile page 208, or other landing page. From there, the user can choose to upload tracks 212 (as described below), view tracks they previously uploaded (if applicable) and saved for later submission 214, view pending tracks awaiting review or multi-rights holder clearance 216, view submitted tracks currently in the system 218, or edit the information or other characteristic data the user entered, for example, during registration step 204.

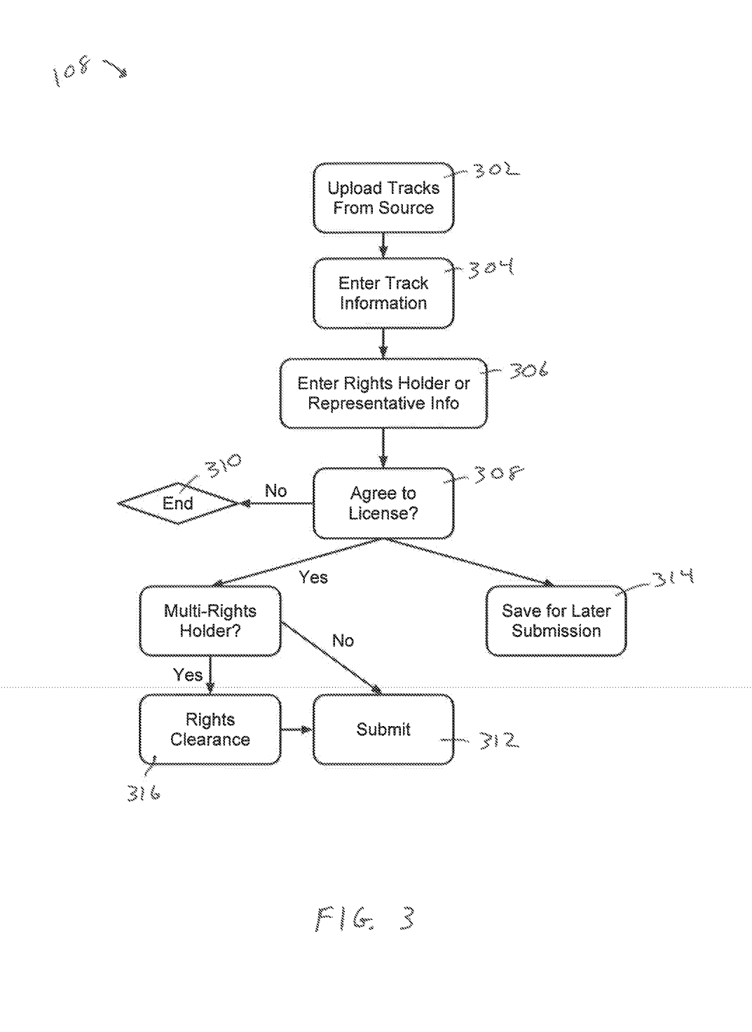

In an exemplary embodiment illustrated in FIG. 3, the intake component 102 can accept one or more digital music tracks via website upload, e.g., from the upload page 212 shown in FIG. 2. Referring now to FIG. 3, following upload from a source 302, the intake component 102 can perform an audio quality check on the one or more digital music tracks to ensure they are of high enough fidelity to distribute to users. This can mean, for example, that the tracks are encoded using a compression-free, or “lossless,” encoding scheme at a bit rate above, for example, 320 kilobits per second (kpbs). In addition, the intake component 102 can perform a volume normalization process to ensure that the one or more digital music tracks do not have inappropriate peaks and valleys in their volume.

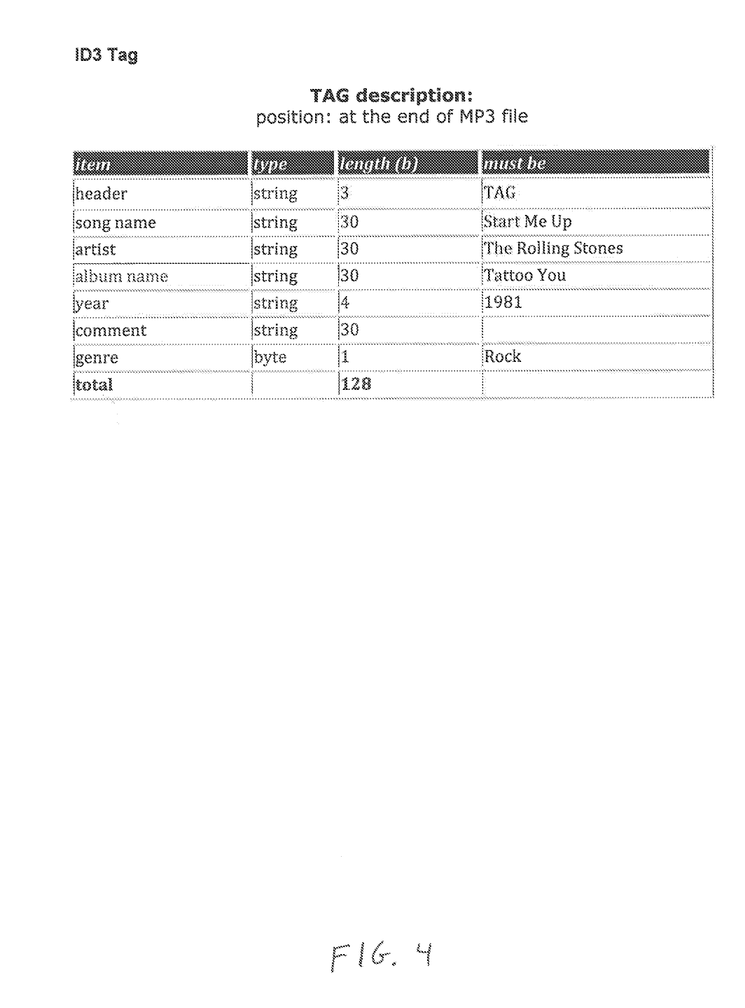

After accepting a digital music track via upload or other intake process (e.g., entry from another content provider's catalog), a preview version of the file can be created and information can be entered about the track, as shown at 304 of FIG. 3. This information, in some embodiments, can come from ID3 tags containing information about the digital music track. The content of an exemplary ID3 tag is illustrated in FIG. 4. Information contained in the ID3 tag can include any of track title, duration, lyrics, performance rights organization, composer/author/publisher (CAE) code, genre, etc. ID3 tag information, however, can be incorrect or missing, so any information extracted from the digital music track can be presented to the user submitting the digital music track for verification and editing, or the user can be prompted to provide similar information if there is no ID3 tag, as shown at 304. Once submitted, the information from the ID3 tag and/or user entry can form the initial record of the digital music track in the system 100. The information in the record can be supplemented in later analyses, as described below.

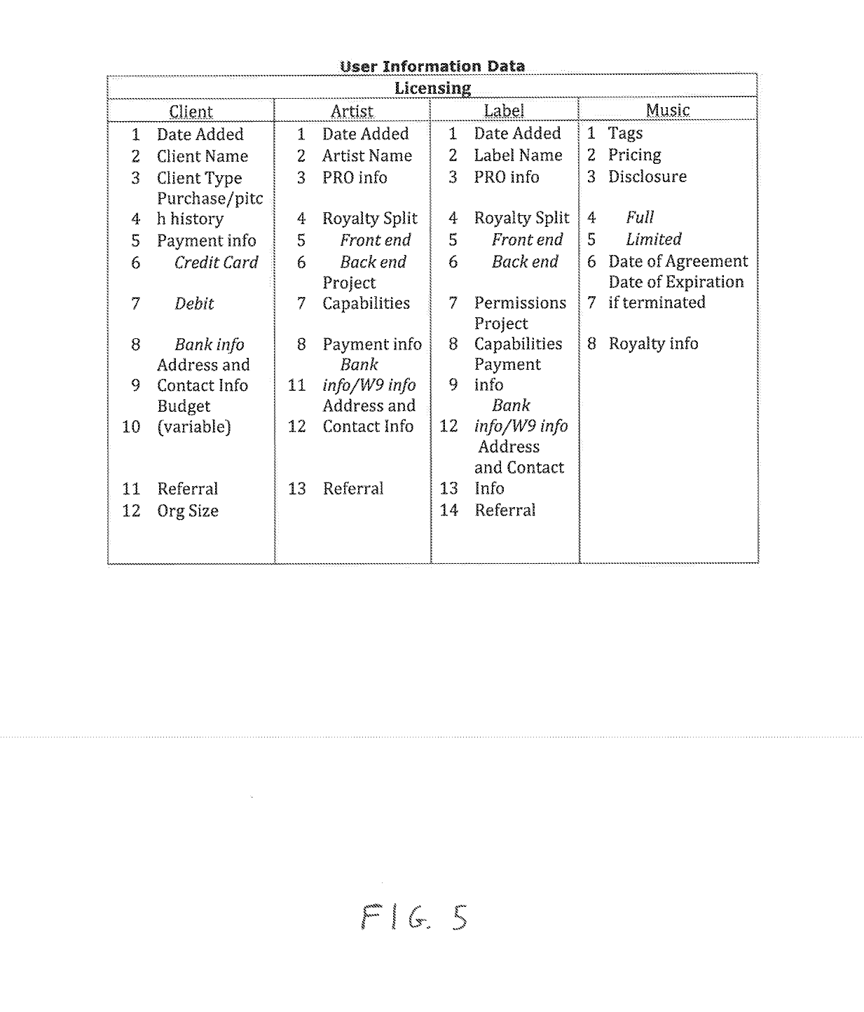

Users can also be asked to provide a variety of additional information at step 304 of FIG. 3. For example, users can be asked to provide identifying information such as a name, address, phone number, email address, and more. Users can also be prompted to provide information for the organization they represent (e.g., a band, record label, etc.), such as artist name, album cover art, artist website, artist biography, social media links, etc. Other examples of information requested during the intake of a digital music track are illustrated in FIG. 5.

Next, users can be prompted to enter information on any additional rights holders or rights holder representatives that must authorize the distribution of the digital music track being uploaded, as shown at 306. This information can include, for example, a rights holder's name, email, and percentage of track ownership. Users can also be asked to specify the particular purposes for which the digital music track is to be licensed. Exemplary purposes can include, for example, media sync licensing, retail music styling, consumer streaming delivery, etc. Based on the user's selection, the user can be prompted to review and accept a licensing agreement between the user and any of the system operator, other rights holders, and other interested parties (e.g., record labels, etc.), as shown at 308. If a user does not agree to the licensing agreement presented at 308, the process can be terminated 310 and the upload aborted.

If the user does agree to the licensing agreement, as shown at 308, and there are no additional rights holders involved, the user can elect to submit 312 the digital music track for entry into the system 100, or the user can elect to save the uploaded track for later submission 314. A user might elect to save a track for later submission if, for example, the user wishes to confirm information entered about the track, as is shown at 304.

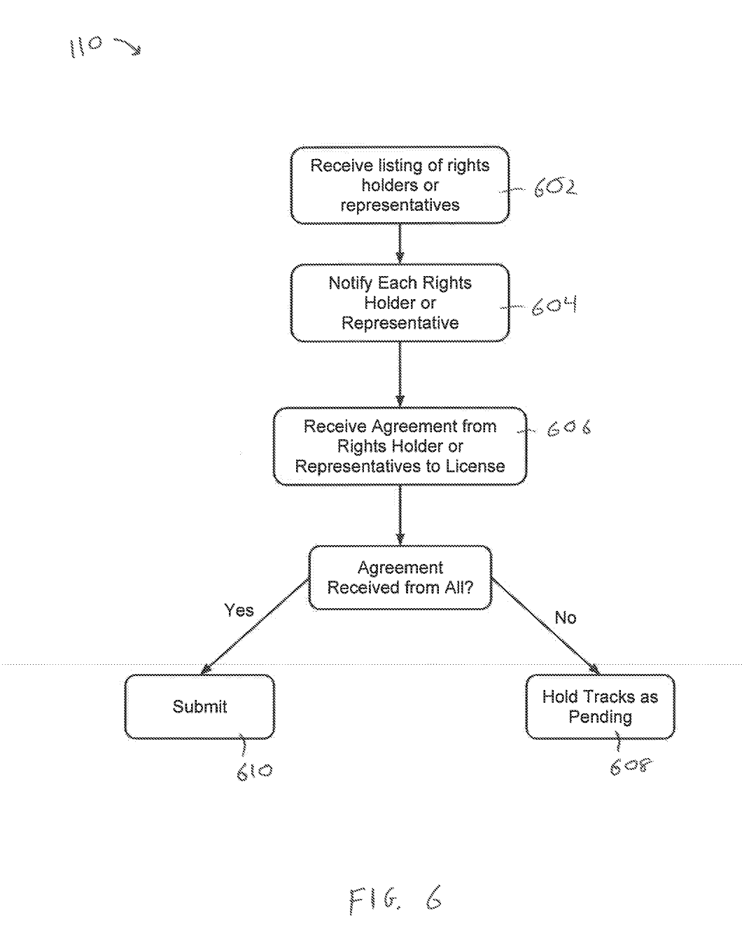

If additional rights holders do exist, the intake component 102 can be configured to perform an additional rights clearing process 316, which is illustrated in FIG. 6. The process can begin by receiving 602 the list of rights holders and/or rights holder representatives entered at 306. Then, the intake component 102 can electronically notify 604 each of the additional rights holders, or their representatives, and can require each of these individuals to also review and accept a licensing agreement with the system operator, other rights holder, or other interested party, as described above and shown at 606. Acceptance of the licensing agreement can be, for example, in the form of an electronic signature entered at a website. In some embodiments, a link to the licensing agreement website can be included in each electronic notification sent during the intake process.

The intake component 102 can be configured to hold 608 any submitted digital music track from delivery to any user until every rights holder accepts the licensing agreement. The submitted digital music track can also be held until a system administrator, or administration program, reviews the digital music track and submitted data for validation purposes. After all interested parties agree to the licensing agreement, the tracks can be submitted 610 for distribution to one or more users.

Analysis

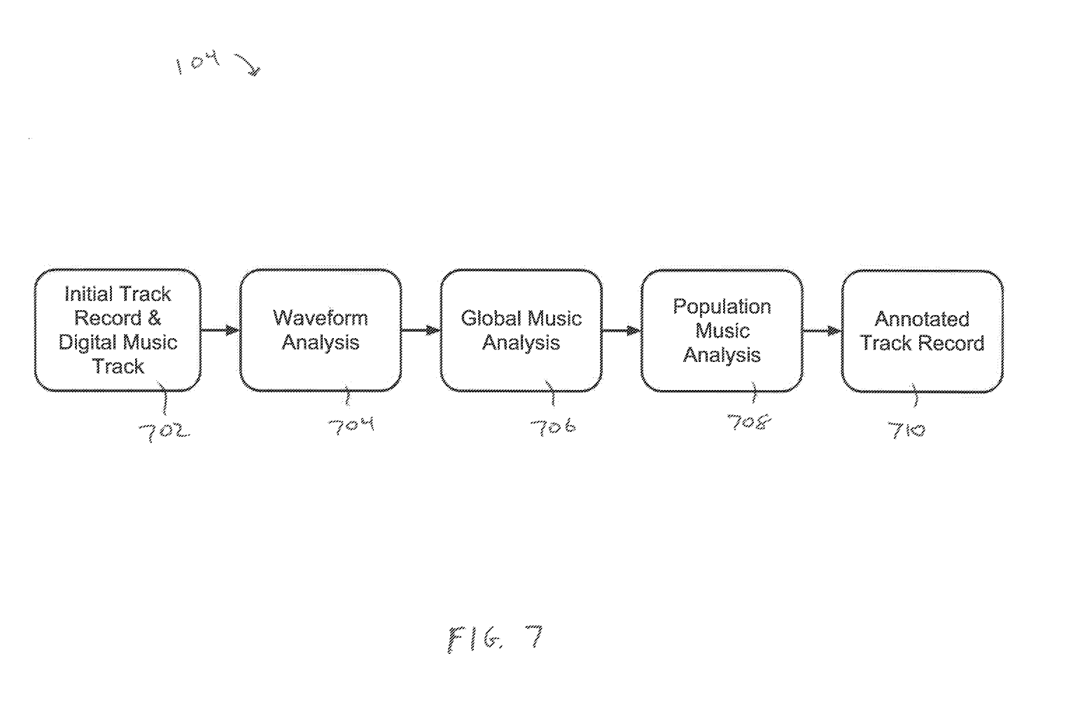

The analysis component 104, illustrated in FIG. 7, can accept as an input the digital music track and an initial record 702 created during the intake process. Alternatively, the analysis component can be configured to operate directly on a digital music file and utilize any associated track information during its analyses. For example, the analysis component 104 can be configured to perform any number of analyses on one or more digital music tracks in order to create a descriptive record of the one or more tracks.

In the exemplary embodiment illustrated in FIG. 4, the analysis component 104 conducts at least three different analyses on a digital music track having an initial record 702 that includes some, or perhaps no, information about the digital music track. A waveform analysis 704 can be conducted on the digital music track to extract inherent characteristics of the music. The waveform analysis 704 can be implemented by a digital data processor configured to execute an algorithm to “listen” to the song (i.e., analyze the musical waveform) and identify characteristics of the music including, for example, tempo, mood, instrumentation, vocals, theme, key, progression, stylistics, etc. An exemplary program for executing this waveform analysis is offered by the company Musically Intelligent Machines LLC, available at http://musicallyintelligent.com. This process can result in several tags, or descriptive terms or phrases, being associated with the digital music track via, for example, inclusion in an annotated record 710 of the digital music track (e.g., one or more database records). An exemplary listing of the themes, moods, and feels that can be assigned to a given digital music track is provided in FIG. 5.

The second analysis performed by the analysis component 104 is a global music analysis 706, which can associate any number of global music factors with the digital music track via its annotated record in the system 100. Global music factors can be derived from any data related to the digital music track provided by external sources (i.e., non system-user information sources). Exemplary global music factors can include consumer music analytics data including sales information and other indicators of commercial success, as well as listener sentiment, listener location, and many other data points related to how, why, when, and where music is consumed. Global music factors can include one or more pieces of demographic information related to music sales. This can include, for example, age, race, gender, income, religion, schooling, occupation, etc. An exemplary listing of demographic information is shown in FIG. 7. Global music factors can further include psychographic information, which can include descriptive words or phrases derived from demographic information, user surveys, etc. Examples of these descriptive phrases include “status seeker,” “urban,” “first adopter,” etc. Sociographic information, such as where someone grew up or their interests, can also be included in the global music factors associated with a given track based on consumer data from outside the system 100.

The data used to conduct the global music analysis 706 can be sourced from any number of data sources outside the system 100. These can include any of websites, magazines, reviews, music commentary sites or posts, social media sites or posts, song sales reports, song streaming reports, as well as music consumer psycho-, demo-, and socio-graphic surveys. In addition, web-based interfaces of the system 100, such as the player interface discussed below, can be configured to track internet browsing behaviors of system users via known methods in order to infer information about the user.

In one embodiment, music consumer surveys can be conducted that ask consumers questions designed to elicit answers that broadly or specifically describe their psycho-, demo-, or socio-graphic attributes (e.g., “are you male or female,” “describe yourself in three words,” etc.). The surveys can also ask consumers questions regarding their specific musical listening tastes and preferences, including what they listen to and when. Using the two sets of questions, correlations can be drawn between particular listening tastes and preferences and particular psycho-, socio-, and demo-graphic attributes.

The third analysis performed by the analysis component 104 is a population music analysis 708 based on data collected from the population of users interacting with the system 100. Population music factors can be very similar to the global music factors discussed above, but are derived from data sources within the system 100 itself. Data sources can include user behaviors and feedback, and can be afforded different weight in certain situations, as discussed below. For example, data for associating population music factors with a particular digital music track can be sourced from tracking usage behavior of system users, tracking data input of system users (e.g., favorite artists, psycho-, socio-, and demo-graphic information entered in a user's profile), system user preference settings, and system user feedback ratings collected during delivery of a digital music track to a user. In addition, the system 100 can include indicators of a particular user's status as an expert, disc jockey (DJ), tastemaker, or other influential person that can be used to weight their preferences differently than other users.

All of these analyses add data to the initial record 702 of a digital music track to create the annotated record 710 that is richly descriptive of the digital music track and its audience. As noted above, the three analyses described are not exhaustive, and the analysis component 104 may be configured to conduct additional analyses. For example, the analysis component 104 can also be configured to conduct a voice extraction analysis on a digital music track to analyze a track, isolate the vocals, and use voice recognition software to extract the lyrics of the track. The lyrics can then be added to the annotated record for the track and used for music searching and selection. In addition, certain words or phrases in the lyrics can be utilized to associate a particular theme or mood with the track. Note that, in some cases, a voice extraction analysis may not be necessary because the lyrics of a song can also be sourced from a third party via the internet during the global music analysis 706.

It should be appreciated that the order of the analyses conducted by the analysis component 104 can be varied. In some embodiments, however, the waveform analysis 704 can be performed before any other analyses because its results can provide meaningful compensation for incomplete data in the subsequent analyses. For example, if global music factor data is available for a first song but not for a second song, the ability of the system 100 to accurately select the second song can be reduced. However, if the waveform analysis 704 indicates that the first song and the second song share a substantial number of attributes in common, it can be possible to associate the global music factors of the first song with the second song to supplement the annotated record 710. The annotated record 710 can then be updated with additional directly related global music factor data, if such data is received in the future.

In addition, the analysis component 104 can be operated at any point during use of the system. For example, the analysis component can operate on digital music tracks uploaded through the intake component 102 even before the tracks have been cleared for distribution to users. In some embodiments, the analysis component 104 operates on any new tracks prior to the tracks being cleared for distribution to one or more users so that a system administrator, or administrator program, can review the information in the annotated record for validation purposes. Finally, the analysis component 104 can continuously, or periodically, operate on digital music tracks in the system 100 in order to update the annotated record 710 based on newly received information from external or internal sources.

Selection

Once a digital music track is added to the system 100, the track can become available for selection by one or more users via the searching and selection tools offered by the selection component 106. The selection component 106 can provide a variety of these searching and selection tools tailored to the type, and purpose, of the system user. Three exemplary usage scenarios are discussed in detail below.

### Licensing Search

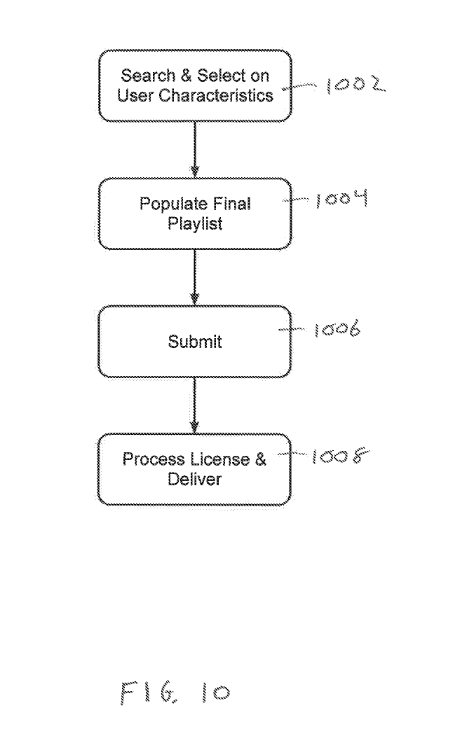

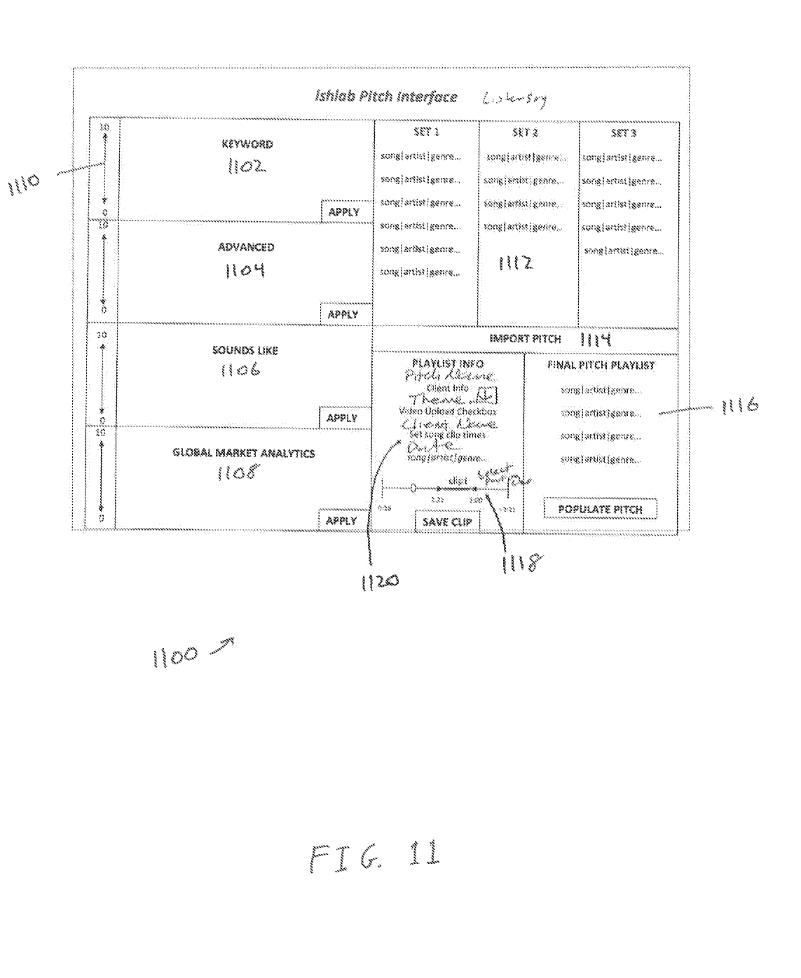

Certain users of the system 100 may be interested in finding a particular digital music track to sync with another media, such as a video. The user requesting music may be the user of the system, or a system user may be searching for music on behalf of a client. In the case of a user searching on behalf of a client, the methods and systems of the invention can provide the user with interfaces for searching, selecting, and proposing the user of particular digital music tracks in a sync project. An exemplary basic workflow for a user searching for music to license for sync projects is illustrated in FIG. 10. After entering the system, the user can first search and select 1002 digital music tracks based on one or more user characteristics (e.g., search criteria defined by the user). These characteristics can include, for example, a desired song mood, song tempo, song genre, etc. To complete these searches, users can be directed to a searching interface, such as the interface 1100 illustrated in FIG. 11, to search for digital music tracks in the system 100 that meet their requirements. As shown in the figure, a variety of searching mechanisms can be presented to the user by the interface 1100, including keyword searching 1102, advanced searching 1104, sounds-like searching 1106, and global music analytics searching 1108. Keyword searching 1102 allows users to search based on one or more freeform words or phrases. Advanced searching 1104 can provide one or more drop down boxes or other selection mechanisms to allow users to select particular characteristics of their desired digital music tracks (e.g., genre, tempo, vocals, psycho-, socio-, or demo-graphic attributes, etc.). Sounds-like searching 1106 allows a user to enter a song or artist that their desired music should be similar to (which can be determined by the system 100 using, for example, data from the waveform analysis 704 in the annotated record 710). In addition, users can upload a song not found in the catalog for comparison purposes, in which case the analysis component 104 operates on the uploaded song for the purposes of determining at least data from the waveform analysis 704. Finally, global music factor searching 1108 can allow a user to specify global music factors such as sales volume or other indication of degree of commercial success.

In certain embodiments, users can enter searching criteria simultaneously in any of the four searching areas. In addition, each searching area has a weight slider 1110 that allows a user to select the weight of the particular search terms entered in that area. The weight can be expressed in a variety of manners and, in some embodiments, is expressed as a numerical scale from 1 to 10, where 10 is the heaviest weight and 1 is the lightest. For example, a user can enter search terms in each of the four search areas 1102-1108, and further assign keyword search 1102 to a weight of 10 while assigning search areas 1104-1108 to a weight of 2. In executing the search, the system 100 will be driven primarily by the keyword matching of search area 1102, as a result of its heavy weight. The system 100 may, for example, return songs matching the keyword search terms even though they do not match strongly on one or more of the other search terms entered into search areas 1104-1108. The weighting and matching selection processes are discussed in more detail below.

In addition, in embodiments where a user is searching for music to response to a request for music by a client, the selection component 106 can be configured to utilize the client request data as additional user characteristics when searching for and selecting tracks for consideration. Further, the selection component 106 can give relatively heavy weight to the criteria of the request such that results presented to a user are filtered not only by the user's specified searching criteria, but also by the client's requested criteria. In this way, the system can deliver tracks relevant to a client's request, regardless of the searching decision a user may make when utilizing the system 100 on behalf of the client.

Moreover, the system 100 can consider licensing price in its search and selection processes. Pricing information can be associated with a digital music track through the annotated record 710 similar to any other attribute associated via the analysis component 104. Content providers can specify, for example, that particular tracks should only be offered for licensing on projects having a budget over a threshold dollar amount. Or, the content provider could specify a set price, range of prices, or floor value for licensing of a particular track. Similarly, users can specify pricing information in the search interfaces using, for example, the advanced searching features. Users can specify any range of pricing criteria including, for example, a set price, a range of prices, a ceiling price, a floor price, etc. The selection component 106 can then match on price (and the importance or weight given to price by the user) similar to any other user characteristic utilized in searching the annotated record 710 to deliver songs that a user is likely to find desirable.

Search results can be delivered to the user in variety of manners. In an exemplary embodiment, a tabular view of selected songs can be displayed as an overlay to interface 1100. Alternatively, this tabular view could be displayed in a new window of the user's web browser. The tabular view can contain information such as the track title, track artist, licensing clearance status, pricing information, as well as an option to preview the song or add the song to a playlist 1112 in the interface.

The one or more playlists 1112 on the right hand side of the interface 1100 can store digital music tracks located via searching for possible use in a project. These playlists can be used as a work space for organizing tracks, or for importing a playlist from a previous project as a starting point. Importing can be accomplished using the import button 1114 and choosing a previous playlist from a user's account history. Users can have any number of playlists, each containing any number of digital music tracks.

A user can then populate 1004 a finalized playlist for licensing or demonstration to another user (e.g., a decision-maker for an advertising organization, etc.). To do so, the selected digital music tracks can be added to a final playlist 1116 shown in the lower right-hand portion of the interface 1100. In addition, the user can select a particular portion of the digital music track for use in the project with the clip selector 1118, and can edit details about the playlist using the playlist information editor 1120.

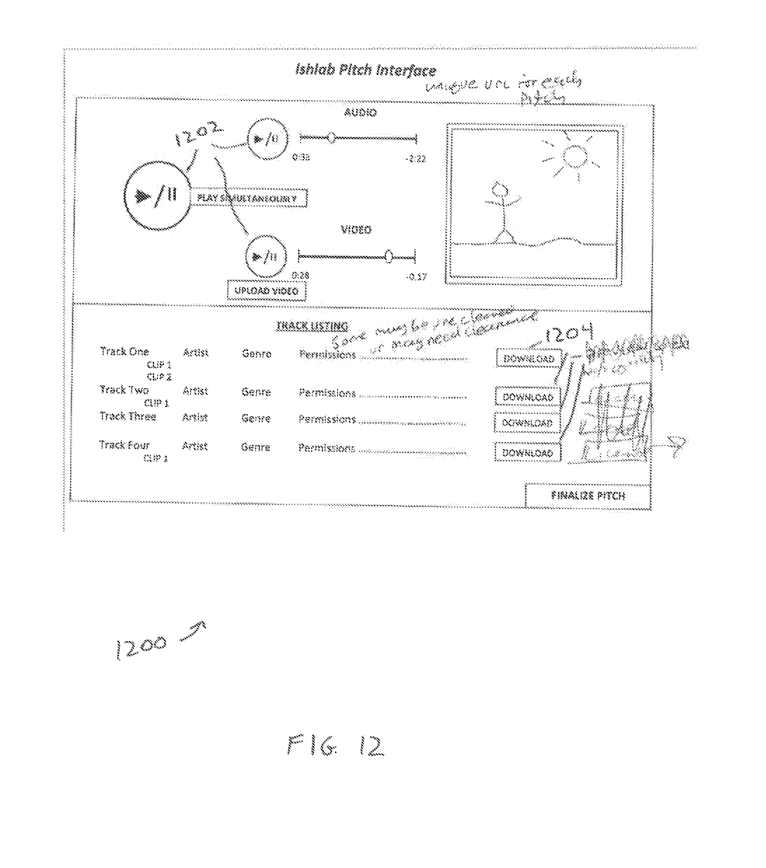

The user can then submit 1006 the final playlist for delivery or demonstration to others, using, for example, a unique website address for the playlist. The unique web address can present to a user, for example, the interface 1200 shown in FIG. 12. The interface 1200 shows a listing 1202 of the final playlist 1116 from interface 1100, as well as a media playback area 1202 that can be used to demonstrate the syncing of the selected digital music tracks with the project media, such as television commercial video.

The interface 1200 can also include buttons 1204 to select the digital music tracks in listing 1202 for licensing. Once this selection is completed by a user, the selection component 106 can pass off to the delivery component 108 to complete the license and deliver the selected digital music tracks to the user, as discussed below and shown at 1008 of FIG. 10.

### Music Styling Search

Other users may utilize the system 100 to select and style music for another user, such as a client. For example, disc jockeys (DJs) are regularly engaged by, for example, retail establishments like clothing stores to create background music styling for their stores. In such a case, the user can be informed about the requirements for the music by one or more criteria specified by the client. These criteria can, in some embodiments, be stored in the system 100 and made accessible to the user through a profile or project webpage.

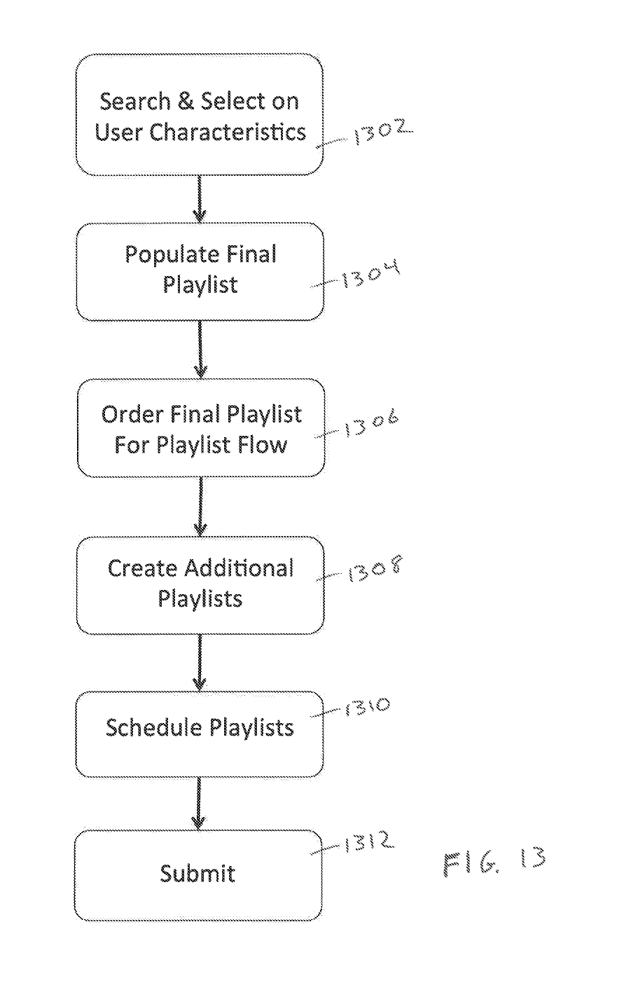

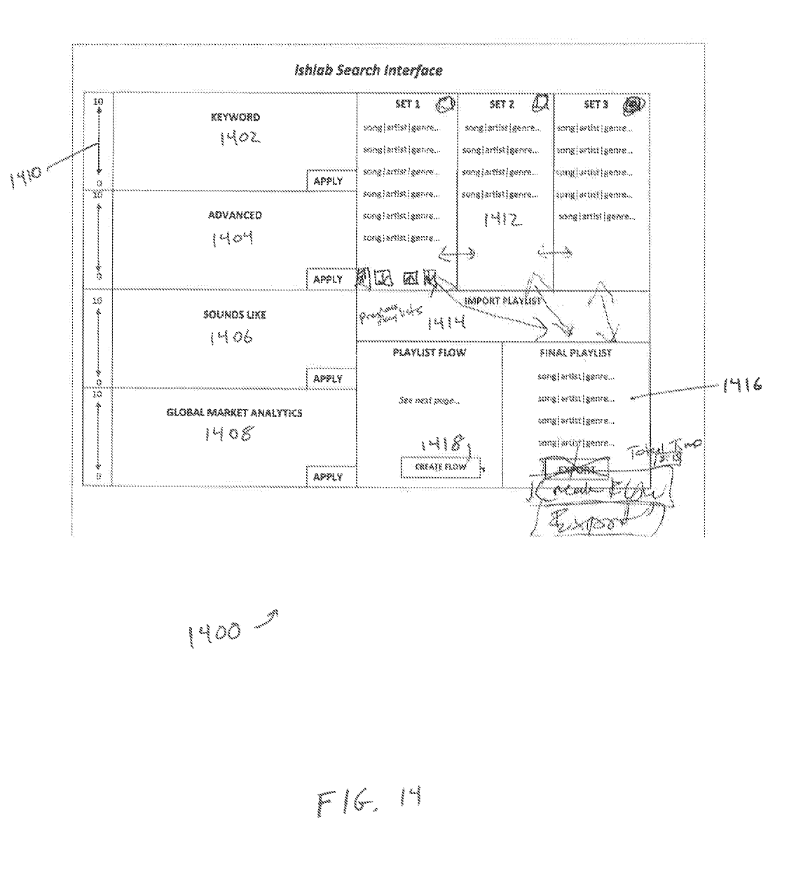

The workflow for such a user is illustrated in FIG. 13. To search for appropriate music and begin assembling one or more playlists 1302 for delivery to the client, a user can be brought to a music searching interface substantially similar to the interface 1100 employed in the music licensing example above. An exemplary interface 1400 is illustrated in FIG. 14. As shown in the figure, the interface 1400 can include the same four searching areas 1402-1408 described above with reference to the licensing search interface 1100. The four searching areas allow a user to search the catalog of digital music tracks in the system 100 using any combination of the data contained in the annotated record 710 of the digital music tracks (i.e., searching criteria can be entered in any of the searching areas 1402-1408 simultaneously to produce, for example, a search that looks for both keywords and songs that sound like a particular song entered or uploaded by the user).

Also similar to the licensing search interface 1100, the interface 1400 includes weight sliders 1410 for each of the searching areas 1402-1408 in order to more or less heavily influence the search results based on a particular searching area 1402-1408. The weighting system can operate in a similar manner as discussed above, i.e., the weight sliders can be movable through a numeric range (e.g., 1-10) where 10 is the heaviest and 1 is the lightest weight. In other embodiments, the weight factors can span a numeric range from 1-5, where 1 is the lowest weight and 5 is the highest. In such an embodiment, the weights can all be assigned to a neutral number by default, such as the number 3. The weight factors assigned by the user can be incorporated into the search of the digital music files in a variety of manners. For example, a search of the annotated record 710 can return a listing of results that match each search criteria ranked by a numeric value representing a relevance match between a search criterion and a digital music track in the annotated record. The weighting factors can be utilized as multipliers to increase the numeric score of tracks having strong relevance in favored (i.e., heavily-weighted) search criteria, while less significantly affecting the score of songs that match on less favored (i.e., lesser-weighted) search criteria. In this manner, results with the strongest relevance in the favored search criteria can be promoted to the top of the search results list.

Search results can be delivered to the user in a tabular overlay or window, similar to the interface 1100 described above. In addition, search results can be immediately inserted into one or more playlist sets 1412 on the right-hand side of the interface 1400. These one or more playlist sets can be used to organize songs under consideration for the client. In addition, a user can import a previously created playlist into one of the playlist sets 1412 using the import playlist button 1414 or a drag-and-drop operation.

Once the user has selected a set of songs to include in a final playlist, the user can move the songs from the playlist sets 1412 to populate the final playlist 1416 in the lower right of the interface 1400, as shown at 1304 of FIG. 13. Once the final playlist is created, the user can elect to create a playlist flow 1306 by pressing the create flow button 1418. A playlist flow allows a user to order the songs in the final playlist to create a fluid and natural progression from, for example, one genre to another or one tempo to another. In addition, the flow can be informed by external factors, such as the time of day or day of the week.

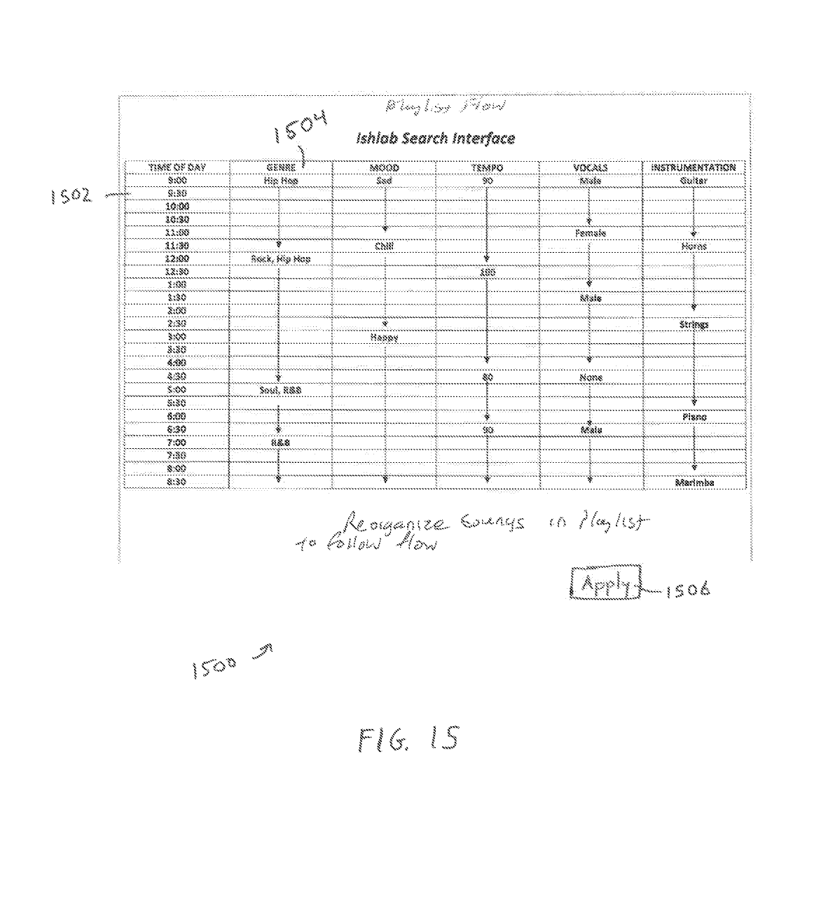

In some embodiments, clicking the create flow button 1418 can bring the user to a playlist flow editing interface, such as interface 1500 of FIG. 15. Alternatively, the interface 1500 can be incorporated into the playlist creation interface without the need for a separate page or interface. The playlist flow interface 1500 can be implemented as a tabular view of the hours in a day, which can be restricted to the particular hours that a client retail store is open. Each row of the table 1502 can represent a particular period of time, such as the 30 minute blocks shown in FIG. 15. Each column 1504 can represent a particular criterion for the music, and each cell in a column can specify a particular value for the criteria at a particular time. More than one column can be included, as shown in the figure, and the columns can be weighted such that the most important criterion for music flow is listed in the left-most column, with each subsequent column decreasing in weight. For example, the columns can include a plurality of criteria including genre, mood, tempo, vocals, and instrumentation. Alternatively, the columns can be equally weighted such that the system 100 selects the most relevant songs overall to be played during a given time period.

Referring to the example shown in FIG. 15, the playlist flow interface 1500 indicates that, from 9:00 AM to 12:00 PM, music of the genre “Hip Hop,” having a “sad” mood, a 90 beats per minute (bpm) tempo, male vocals, and guitar should be played. Should no song from the final playlist match these criteria, a song can be selected that most closely matches to the genre column, and then the mood column, etc.

The user is able to set the values in the cells of the playlist flow interface 1500 based on the requirements of the client or the creative vision of the user. Once the flow is established, the user can, for example, click an apply flow button 1506 to cause the selection component 106 to sort the songs from the final playlist 1416 into an order matching the playlist flow created by the user. After reordering of the final playlist, the user can be presented with the new ordered final playlist in an overlay or new window to review the list. The user can elect to edit the final playlist order to override the playlist flow ordering if they so desire.

Following creation of a final playlist and playlist flow, the user can submit 1312 the playlist for delivery to a client or, in some embodiments, for review by an administrator or administrator program that can to perform validation and quality control checks on the playlist.

In some embodiments, a user may be engaged to create a playlist that will be played repeatedly by, for example, a retail store or other client. For example, a retail store may request a series of digital music tracks to be played for 8 hours a day, 3 times a week. In order to provide a user with the ability to easily create variations of their final playlist, the selection component 106 can include an interface that allows a user to randomize a final playlist in order to create a variation (e.g., to be played on the second day of the week in the example above). However, simple random re-ordering of the tracks in the final playlist can significantly affect the playlist flow in an undesirable manner. Accordingly, the selection component 106 can utilize alternative randomization schemes, such as a chunk randomization process, to create a variation of a final playlist while minimizing any disturbances to the playlist flow.

Chunk randomization can be performed in a variety of manners. In one embodiment, a user can define chunks of songs within the final playlist order, where those chunks encompass more than 1 song but fewer than all of the songs in the playlist. In some embodiments, the chunk sizes range between 3 and 7 songs. The selection component 106 can then randomize the songs within each chunk, but the order of chunks remains the same. This randomization method can preserve the playlist flow while creating a non-repetitive permutation of the playlist. In other embodiments, the selection component 106 can automatically create the chunks by selecting a series of songs in sequence randomly. The selection size of these chunks can be configured but, in some embodiments, the chunks are between 3 and 5 songs in size. In still other embodiments, the selection component 106 can utilize the playlist flow to select chunks based on when changes in the playlist flow occur. For example, referring back to the playlist flow interface 1500 of FIG. 15, a change in genre is present after 3 hours, 5 hours, 2 hours, and 1.5 hours, and changes in vocals are present almost every 2 hours. The selection component 106 can be configured to, based on these times, select chunks of songs spanning these time periods to avoid disruption of the playlist flow. The time periods in this example are much longer than 3 to 7 song periods and, as a result, the selection component 106 can be configured to include changes in other playlist flow criteria (e.g., tempo) as well in order to reduce the time spans. Alternatively, the selection component 106 can be configured to define 3 to 5 song chunks as disclosed above, but to ensure that a chunk does not span a time period in which a change in playlist flow occurs (i.e., the selection component can select 3 to 5 song chunk sizes such that one chunk ends and another begins 3 hours into the playlist when the change from “Hip Hop” to “Rock, Hip Hop” occurs).

In other embodiments, randomization can be limited to particular time frames rather than song sets or chunks. In such an embodiment, the selection component 106 can be configured to define time periods and to randomize all songs scheduled to play within a time period. For example, all songs within a two hour period during the middle of the day can be randomized, while songs outside of the time period remain in order.

In certain embodiments, randomization of all songs can be employed, but at varying strengths of randomization. For example, all the songs in a playlist can be randomized at 50% strength, meaning that approximately half of the songs in the playlist remain in their original position in the playlist, or original position with respect to adjacent songs. Increasing the strength of randomization results in a larger percentage of songs being moved from their original position in the playlist.

In still other embodiments, the user can utilize the automatic music selection capabilities of the selection component 106, which are discussed in further detail below, to automatically create 1308 a new playlist containing all, or substantially all, new songs, but where the new songs share one or more musical characteristics with the songs of the original, user-created playlist. Using this feature of the selection component 106, a user can create any number of playlists that are non-repetitive in order as well as content, without searching for and selecting new music. The user can simply edit the system-created playlists and submit them for delivery to a client.

After a sufficient number of playlists have been created (e.g., 4 additional playlists have been created for a playlist that is to be played 5 times a week), the user can schedule 1310 the playlists for a client using an interface that represents the days of the week and times of the day that a client has requested music styling. The user can select playlists to be played during each of the time periods and either submit 1312 the schedule for delivery to the client or review by an administrator or administrator program (e.g., to conduct validation and quality control inspection, as discussed above).

Once the playlists and schedules created by the user are cleared for delivery to the client, the selection component 106 can pass off to the delivery component 108 to deliver the selected digital music tracks to the user, as discussed below.

### Automatic Selection

In still other embodiments, a consumer or other user may desire to stream music for their personal enjoyment without having to engage a DJ or otherwise exhaustively search for music. In other words, the user may “just want to hear good music.” In such a case, the selection component 106 can utilize searching and weighting algorithms, similar to those that power the licensing music search and music styling search examples above, to select music that a user is likely to enjoy based on user characteristics, i.e., information known about the user and the music they desire.

However, selecting music can be more difficult because, in some examples of this usage scenario, a user may not provide any searching criteria like the users in the prior examples. The system 100 needs some piece of information from which to begin matching music selections against the annotated record. This information can come in a variety of forms. For example, when a user signs up to access the system 100 to listen to music, the user can be required to complete a questionnaire (similar to the process illustrated in FIG. 2 for users wishing to upload digital music tracks) containing questions directed to the user's psycho-, socio-, and demo-graphic attributes, as well as to their specific music listening preferences. This information can be used to create initial selections of music, or types of music, to deliver to the user. For example, a user can be asked during the sign-up process for his or her sex, age, income, home address, etc. The listener can also be asked directly if they have a favorite artist, song, era, genre, etc.

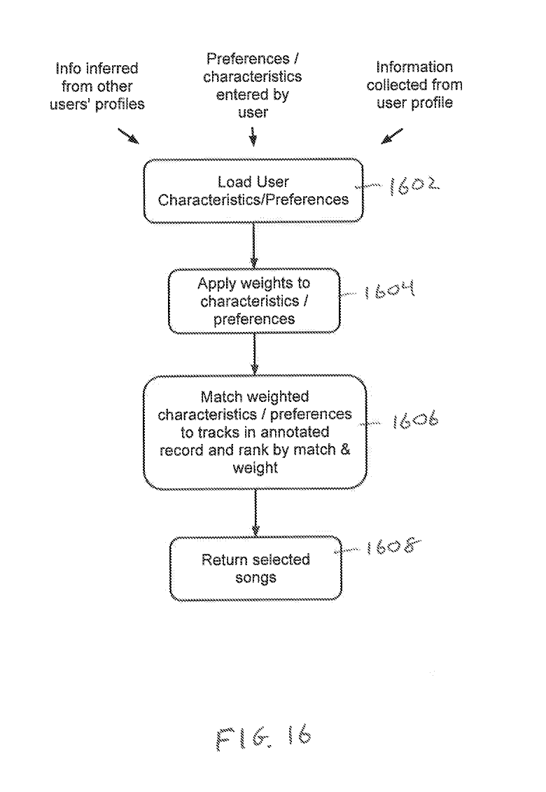

The user may also be asked questions designed to assess how open to suggestions from others they are. An exemplary question can ask “do you think of yourself as a music or fashion expert?” Alternatively, or in addition, the user could be prompted to explicitly state their preference for the influence of others in selecting digital music tracks. For example, the selection component 106 can be configured to use only data from a specific user without any outside influence, or to use specific user data and other user data in a one-to-one weighting, or to use other user data more heavily in a two-to-one weighting, or to use only other user data in selecting tracks for a user. In some embodiments, this selection can be implemented as a slider or percentage ratio that allows users to set any of a range of values. All of the data represents the user characteristics received by the system 100 that can be loaded 1602 into memory and utilized to select digital music tracks for a user, as shown in FIG. 16.

After the selection component 106 acquires a threshold amount of information about a user, it can begin selecting and ranking tracks by matching 1606 user characteristics against information in the annotated record 710. Any criteria/preference/user characteristic for which information is available can be utilized, e.g., if a user specified a favorite genre in a sign-up questionnaire, then selections from that genre could be delivered (or selections from that genre and age group, etc.).

In addition, the selection component 106 can weight differently users who, for example, consider themselves experts, or have some objective indication of being an expert (e.g., an established DJ or system administrator), as shown at 1604. In this manner, the selections of these users can more heavily influence the tracks selected for delivery to a particular user. Aside from users who identify themselves as experts or have some objective indication of being an expert, the selection component 106 can weight higher users who appear to be experts based on the opinions of other users. For example, if a large number of users follow the selections of a first user (e.g., by listening to playlists created by the first user, requesting tracks liked by the first user, or closely following the first user's preferences), then the system 100 can assign a higher weight to the feedback and selections of the first user. As a result, if the first user and a second user both make recommendations, the recommendations of the first user can be given more weight. A user, then, can become a tastemaker by the actions of other users.

As a user specifies more information, the selection component 106 can make use of the information to more accurately select digital music tracks. For instance, while a user may not enter any information about the music they desire to hear in a given session, they also can have the ability to enter that information if they so choose. Examples include a user requesting songs that sound like a particular artist or song, or are from a particular era, or suit a particular purpose (e.g., “songs for the beach”). All of these become additional user characteristics that are received by the system 100 and utilized in selecting tracks for distribution to the user. In such a case, the selection component 106 can more heavily weight the specified criteria than the other information possessed about a user's preferences. In some cases, this weighting can be a two-to-one ratio.

One example of this weighting is a user requesting music by geography. The user can, for example, ask for popular Mexican songs. The selection component 106 can then weight music rated favorably in Mexico more heavily (e.g., two-to-one) than other criteria for which information is available.

Moreover, users can have the ability to create playlists or search for music using any number of searching criteria. For example, a user can create a simple playlist based on songs or artists they enjoy (or do not enjoy), genres they enjoy, eras, they enjoy, or DJs they enjoy. A user can also create a more customized playlist by specifying additional factors such as mood and tempo of the music. An even more customized playlist can be created by the selection component 106 if the user specifies the additional criteria of purpose/place/event/theme, time of day for the music, remixes/covers/samples, psycho-, socio-, and demo-graphic attributes they want to highlight, record label, etc. The more criteria that are specified, the more accurate the searches for music can be.

As users specify more and more criteria for their music selections, it can become helpful to provide a weighting system for the criteria to allow the user to specify those criteria that are most important. For example, the selection component 106 can, by default, be configured to order particular criteria more heavily than others. An exemplary ranking can place waveform analysis and identification data as most highly ranked (tempo, vocals, instrumentation, etc.), followed by user data popularity generally (including global data), system user popularity, psyco-, socio-, and demo-graphic group popularity, purpose/theme, and geographics/location. In addition, heavier weighting can be applied to criteria for song names, artist names, genres, and eras, as well as demographic information such as where a user has lived, their age, their gender, their education, their income, their level of open-mindedness, their personality type, their religion, etc.

In all of these systems, more data on a particular criterion equates with a greater amount of weight given to the criterion. For example, even if the purpose or theme of a music selection normally ranked below other factors (as in the example above), it could be weighted more heavily than the other factors if more data exists in the system about the purpose or theme than any of the other factors. The corollary to this is that a criterion or category of searching that has no data will carry no weight, meaning it will not influence digital music track selection for a user.

The selection component 106 can implement a weighting system in a variety of manners. For example, and as discussed above, weighting can be implemented by using numerical range weights as multipliers for the score of a relevancy match for each criterion being used to select digital music tracks. For example, when a heavier weight is assigned to a playlist purpose, such as “gym music,” search results having a high relevancy score for that purpose can be multiplied to push their relevancy score even higher. Likewise, songs that match well on other, lesser-weighted criteria (e.g., genre) are not similarly increased because of the lower weighting factor (i.e., lower multiplier).

Still further, the total relevancy score for a given digital music track can be computed, for example, as the sum of its relevancy scores for each criterion used in a search. In such an embodiment, even if many songs score highly on the “gym music” purpose, they will remain generally in order based on the matching of other, lesser-weighted criteria.

An exemplary formula for such a relevancy scoring system can be:

Total Score=(weight multiplier₁)*(criteria relevancy score₁)+ . . . +(weight multiplierₙ)*(criteria relevancy scoreₙ)

In another embodiment, a tally system can be utilized to track and measure the matching of a digital music track against a user's tastes. In a tally system, every action taken by a user in the system 100 can be assigned a tally value for a particular category, such that a user can be represented by their tally scores across the many categories of data present in the annotated record 710. For example, a user who heavily favored rock music would have a very large tally score for the genre “Rock.” Expanding this system across all of the many data categories/criteria in the annotated record 710 produces a unique pattern of tally scores for each user of the system. The selection component 106 can then select music tracks based on what other users with similar tally score patterns have rated favorably.

While the example above is simple for the sake of illustration, it should be appreciated that the tally score pattern of a user can become very complex as additional data is gathered about the user. As a result, more sophisticated matching can be done between the tally pattern, or portions thereof, of the users in the system 100 to more accurately select digital music tracks that will be enjoyed by a particular user. As a result, tally patterns can be constantly evolving as users interact with the system 100, such that two users who have similar tally patterns on a first day do not share similar tally patterns on a second day, based on their respective listening interactions and feedback ratings between the first and second days.

Another important aspect of the intelligent learning of the selection component 106 is that the selection component 106 can, over a sufficient period of time and with a sufficient amount of data, begin to learn a particular user's interpretation of a particular category or criteria for music selection. For example, a first user may consider country music to be very different from what a second user considers to be country music. Further, the first user may only like a specific type of country music (e.g., fast tempo). The systems and methods of the present invention are able to learn this behavior over time by associating (e.g., via matching of tally score patterns or weighted relevancies) the user with other users that prefer the same type of country music and by learning from the user's active and passive feedback in the system (e.g., skipping songs, liking/disliking songs, etc.). The end result can be that both the first user and second user have a general playlist for the genre “country music,” but the two users are delivered very different track selections based on their preferences.

The selection component can provide a variety of additional features to improve a user's experience interacting with the system 100. For example, the user can elect to have the selection component 106 prevent the selection of tracks the user has listened to in the past. This can be limited, for example, to a time period, such as the last month, or a certain number of track plays, such as the last 100 songs. Alternatively, a user can request to hear only original tracks that have been sampled by other artists, or to hear only songs by bands from Brooklyn, N.Y. that have been released in the past 100 days. These kinds of criteria can be entered, for example, in a search interface similar to those described above. In addition, the selection component 106 can provide one or more interfaces to allow the user to schedule their playlists for particular times of the day or days of the week. These interfaces can be similar to the scheduling interfaces described above with respect to the music styling example.

Further, the selection component 106 can be configured to automatically acquire and add to the catalog of the system 100 one or more digital music tracks that are not in the catalog and, based on global music data, would likely be desired by one or more users. Finally, the selection component 106 can also be configured to create a “super” general playlist that takes data from any of a user's playlists and combines it together to create a more random mix playlist that still consists of only music identified as desirable by the user.

After selecting tracks by matching user characteristics against data contained in the annotated record 710, the selection component 106 can return 1608 a list of selected tracks. This can be implemented in a variety of ways, including the display of a list of selected tracks, populating a playlist, or passing the selected tracks to the delivery component 108 for delivery to a user via streaming play, etc.

Delivery

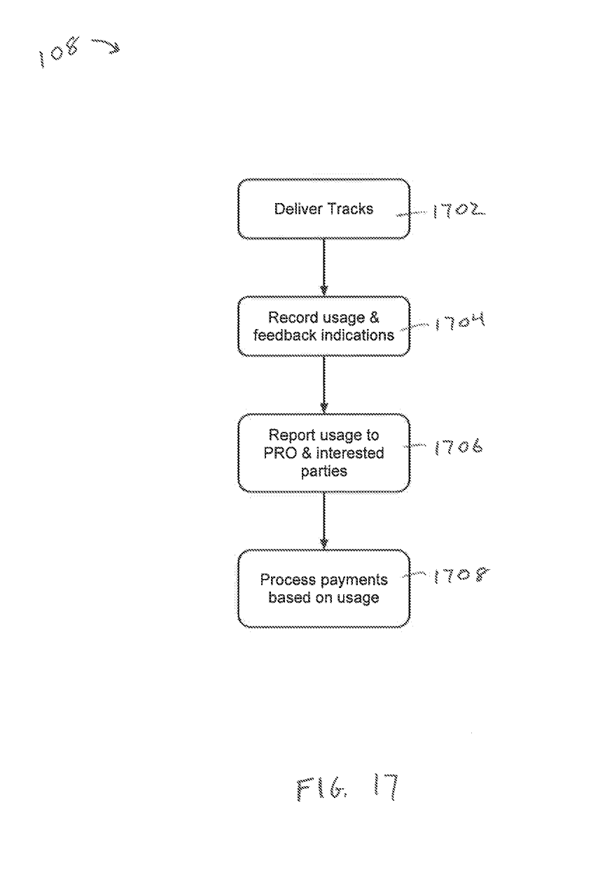

The delivery component 108 can be configured to handle delivery of selected digital music tracks, feedback collection from a user, reporting of track selection or use to one or more interested parties, and payment processing of royalties based on usage, as shown in FIG. 1. In particular, and as shown in FIG. 17, delivery component 108 can, in some embodiments, be configured to deliver 1702 selected digital music tracks to a user, record 1704 all usage by the user as well as the user's feedback indications, report 1706 track usage to relevant licensing groups (e.g., PROs) and other interested parties, and automatically process 1708 payments based on usage and existing licensing agreements.

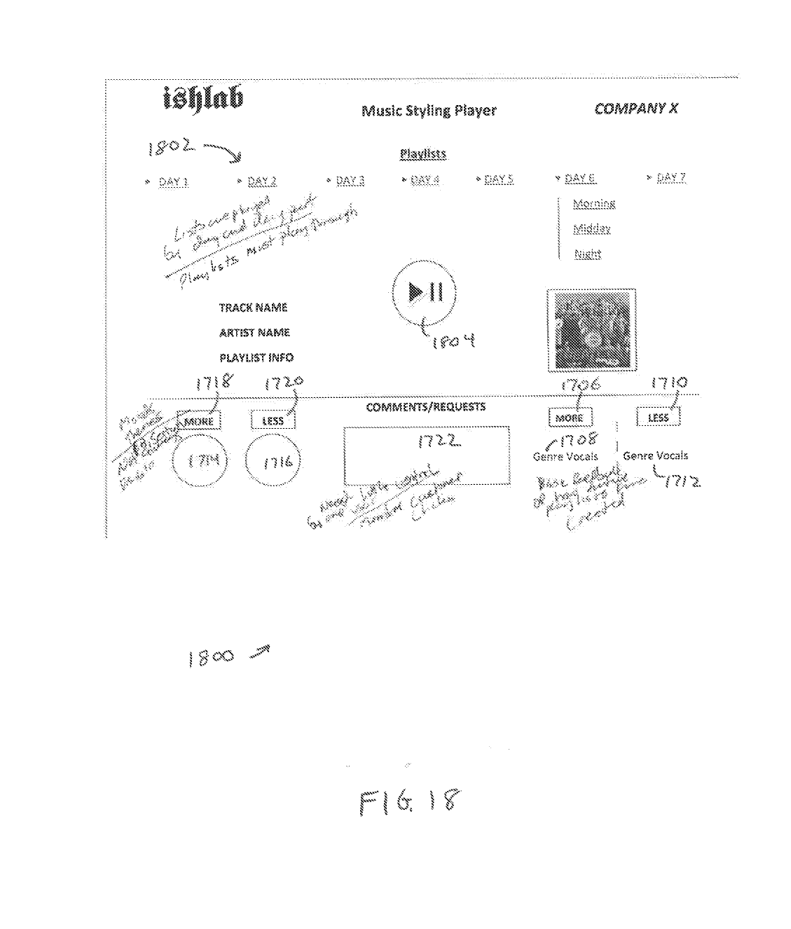

Digital music tracks selected for a given user can be delivered in a variety of manners. In some embodiments, the delivery component 108 can include one or more streaming web-based interfaces to provide the tracks to a user and collect feedback from the user. An exemplary embodiment of a player interface 1800 is illustrated in FIG. 18.

Player interface 1800 is an exemplary interface that can be shown to a client receiving music styled by a DJ or other user, as described above. The interface 1800 can be a website that provides controls for playlist selection, track play, and feedback submission. In particular, The interface 1800 can include a listing 1802 of any of the days and times (or time periods) that the client has requested music styling (e.g., the days and times that a retail store is open). The player can be configured to automatically begin playing the playlist assigned to the particular day and time that the user begins their session (i.e., opens the player interface 1800 via a web browser or other application).

Interface users can be provided with playback controls 1804 to pause, stop, or skip a particular song. In addition, the interface can provide users with the ability to choose an alternate playlist if they desire. The player interface 1800 can be configured to limit a user's ability to change the music styling consistent with any licensing provisions. For example, the system can limit users to no more than three skipped songs per hour, can prevent the same playlist from being played more than twice a day, or can prevent a user from selecting an alternate playlist more than three times a day. Numerous variations of these limitations are possible depending on the particular licensing terms of the tracks selected for delivery to the user.

Still further, the interface 1800 can, in some embodiments, provide users the ability to implement randomization of the playlist. For example, the interface 1800 can provide users with an option to implement the same randomization techniques discussed above with respect to the user selection of music and playlist creation for music styling applications.

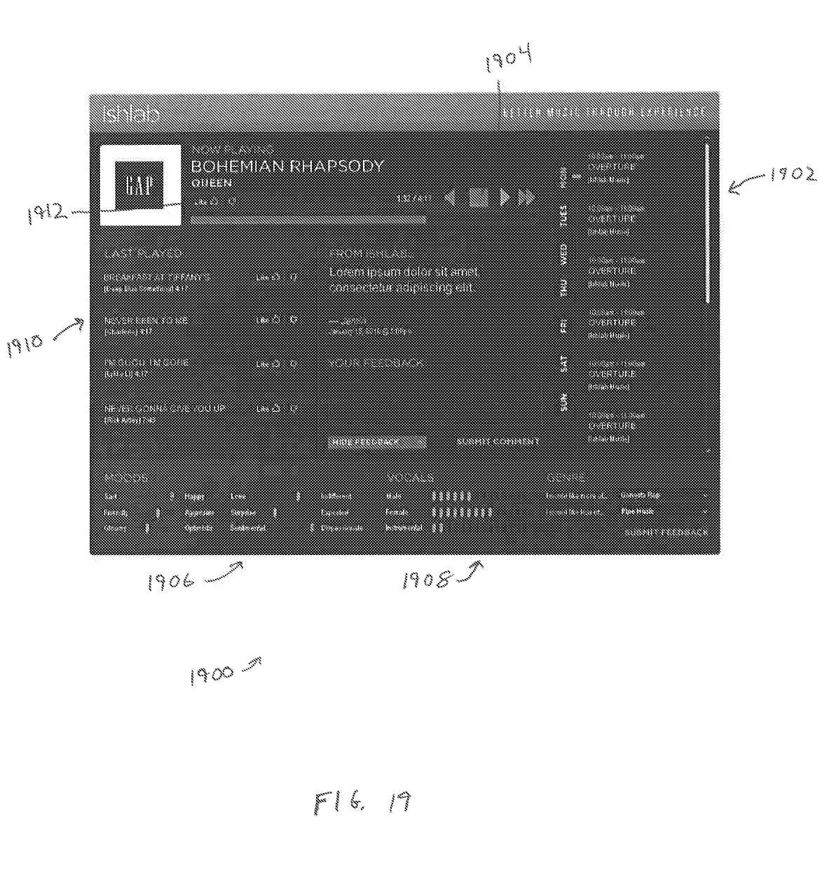

FIG. 19 illustrates another embodiment of a player interface. Similar to the interface 1800, the player interface 1900 includes a listing 1902 of the days, times, and playlists available to the user. The interface 1900 also includes playback controls 1804 to pause, stop, or skip a particular track.

The player interface can include several features to enhance the playback of music, especially the transitions between adjacent songs in a playlist. For instance, the delivery component 108 can be configured to automatically blend the beginning of a second song with the end of a first song. This can be accomplished, for example, by creating time markers in the second song on a downbeat (e.g., beat one) of a cycle at, for example, 4 measure intervals. Markers can be created from the beginning of the second song through a specified time in the song, which can be measured by actual time or number of bars. The process can then be repeated for the first song, however, the markers are created starting from the end of the song and progressing back a specified length of time (or number of bars). With the time markers in place, the player interface can begin playing the second song when the first marker is reached in the first song. The two songs will then play together as the first song ends and the second song begins.

If the songs have different tempos, the delivery component 108 (or player interface specifically) can be configured to gradually slow or accelerate the tempo of either the first or second song in order to bring the two in sync. For example, if the second song has a faster tempo, then the first song can be gradually accelerated during a time period in just prior to the first marker. When the first marker in the first song is reached, the second song can begin playing at the current tempo of the first song. The two songs can continue to accelerate in tempo while playing together until the first song ends and the second song is left playing at its original tempo. Alternatively, the tempo of the first song can be maintained, and the second song can be adjusted to match that tempo until the first song ends. A number of variations of these methods are possible to better sync two songs having different musical characteristics like tempo, volume, pitch, key, etc. The delivery component 108 can also align the rhythm of a first song and a second song such that a first beat of a first song aligns with a first beat of a second song in order to smooth the transition between the two songs.

The player interface can also allow users to set longer time horizon tempo maps to control the playback of music. For example, a user can specify that during an hour period the global tempo (e.g., the average tempo) of all songs played should be within a range from, for example, 100 bpm to 130 bpm. Users can also specify a change, such as the average tempo over a period of time should start around 100 bpm and increase linearly to 130 bpm. The player interface can be configured to arrange the digital music tracks, or adjust the tempo of those tracks, to meet the desired specifications.

Any blending or mixing features can be enabled or disabled by a user through the player interface. In addition, users can set hard start and stop times for each song based on a specific time or measure marker of the song. Alternative, in some embodiments, users can configure the player to loop a portion of a first or a second song when mixing the two songs together during a transition from the first song to the second song. For example, a certain set of measures (e.g., measures 4-16) of a second song can be looped continuously until a first song finishes playing. Users can also configure the player interface to utilize cross-fading volume (i.e., increasing the volume of a second song and decreasing the volume of a first song) when transitioning between songs. The player interface can be configured to utilize a number of different cross-fading profiles, including linear, parabolic, custom curve, and equal gain.

In other embodiments, the player interface can allow users to configure transitions that utilize an intelligently timed delay between a first song and a second song based on the tempo or any other characteristic of the songs. For example, the player interface can be configured to add time markers to a first song as described above (e.g., adding markers on a downbeat, or any other beat, of the song), and the player interface can be configured to immediately stop play when a particular beat marker is reached. The player interface can further be configured to wait a specified period of time (e.g., a period of rhythmic time such as a number of beats, or two measures, etc.) and then begin the second song at a specified marker created in the second song (e.g., a specific downbeat or other beat in the song). Through the player interface, users can specify options specific to a particular song or group of songs, such as the use of a high or low frequency filter, or the use of additional delays (e.g., a ⅛ note delay).

Each of the features related to the mixing of various songs in a playlist disclosed above can be implemented automatically by the delivery component 108 using pre-selected values or mixing schemes, or can be provided as options for users to select using the player interface or another interface dedicated to mixing control. The features can also be provided to music styling DJs or other users creating playlists for another user. For example, these features can be provided in the music styling interfaces 1400, 1500 described above to allow DJs or other users to create playlists that, for example, follow a long-term tempo map (e.g., the playlist flow editor can be used to specify a tempo profile over time, as described above) or exhibit certain mixing behaviors during playback.

The player interface can also include one or more features designed to capture feedback from a user. Referring back to FIGS. 18 and 19, player interfaces 1800, 1900 can include several feedback collection features. Interface 1800 can include one or more buttons, drop-down menus, or other graphical selectors to allow a user to request more or less of a particular type of music. For example, interface 1800 can include button 1806 to request more of the genre selected in drop-down menu 1808. Similarly, the interface 1800 can include button 1810 to request less music in the genre selected in 1812. The drop-down menus or other graphical selection elements can allow users to select and provide feedback based on any number of musical characteristics.

For example, mood indicators 1814, 1816 can present colors representative of the mood of the song (with or without accompanying descriptive text). Buttons 1818 and 1820 can be used to request more or less (respectively) music having a similar mood. Interface 1800 can also include a free-form text field 1822 to collect comments from a user. Text submitted through the field 1822 can be keyword searched by the system 100 to extract relevant feedback, or can submitted to an administrator or music styling user (e.g., the DJ that created the playlist) for review.

Player interface 1900 shown in FIG. 19 includes additional exemplary feedback collection mechanisms. The interface 1900 can include one or more sliding selectors 1906, 1908 to allow a user to request music that is, for example, more happy, more aggressive, more male vocals, more female vocals, less instrumental, etc.).

A listing 1910 of recently played tracks can also be presented to the user so that feedback can be collected even if the user is not interacting with the interface 1900 when a particular track is actively playing. Each entry for a track (including the currently playing track) can include a simple feedback collector, such as a set of like/dislike buttons 1912.

In addition, the player delivery component 108 can track all user interactions with, for example, a player interface 1900 in order to collect passive indications of feedback in addition to the feedback actively submitted by a user. For example, the delivery component 108 can record all tracks skipped, alternate playlists selected, reordering of songs, during of songs played, etc. in order to infer user feedback regarding a particular song or playlist.

All feedback indications, both passive and active, can be incorporated back into the annotated record 710 and user characteristics in order to increase the accuracy of future selections for any user. For example, feedback ratings of a particular song, in combination with user demographic data, can be incorporated back into the annotated record 710 of a particular digital music track as part of the population music analysis 708. Accordingly, a user's feedback rating on a digital music track may influence the selection of the digital music track for another system user that shares, for example, similar demographic attributes.

Feedback ratings can also be incorporated into the listening preferences or user characteristics known about a particular user. For example, a “dislike” rating of a particular digital music track can be used to ensure that the particular track is not selected for the user in the future, even if other data suggests it as a match for the user. In order to accomplish this, feedback ratings can be linked into the weighting schemes described above. For example, direct feedback ratings can be weighted very highly so that they exert greater influence on the selection of digital music tracks than other sources of information. Alternatively, the system can be implemented such that particular types of direct feedback ratings (e.g., an unfavorable rating of a track) provide a prohibition against a user seeing the track again ever.

A player interface similar to interfaces 1800, 1900 can be presented to users, such as consumer listeners, utilizing the automatic music selection processes described above. Moreover, the interfaces presented to such a user can include elements from each of the search, playlist creation, and playlist management interfaces discussed herein. This provides users with an ability to simply listen to music selected for them by the system 100, or to provide the system 100 with information about their desire to hear music of a certain type, tempo, etc.

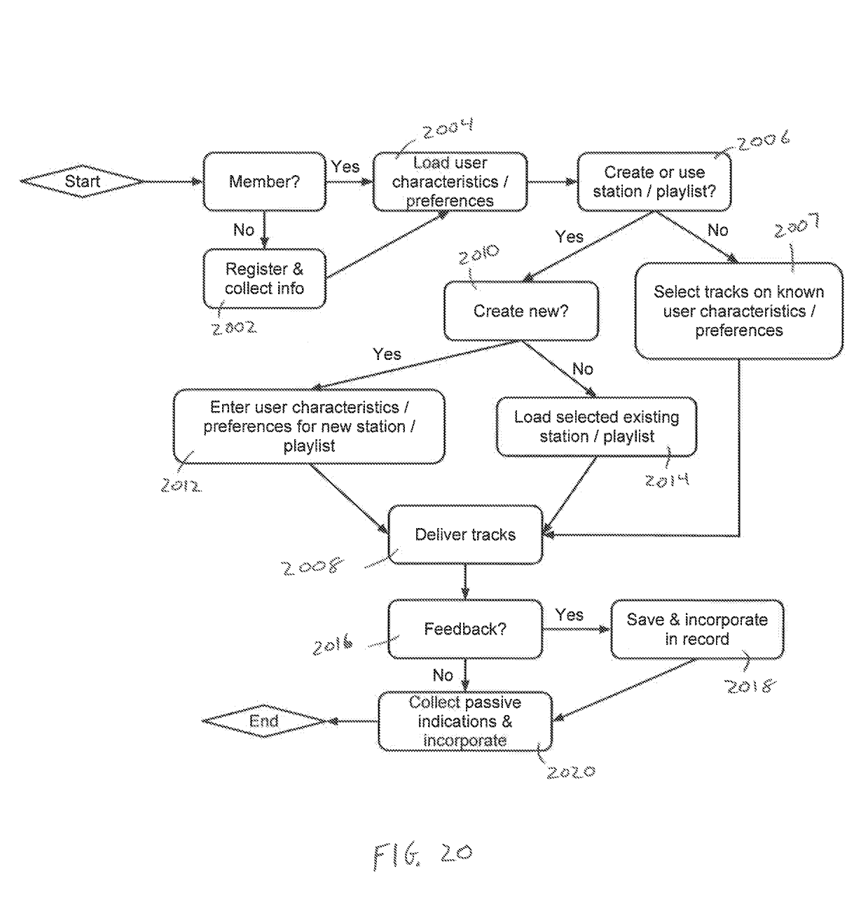

FIG. 20 illustrates an exemplary workflow for a user interacting with the automatic selection component 116 of the system 100. To begin, a user logs in to, for example, a website used to interface with users and provide streaming music. If the user is not already registered, the user can elect to register 2002 and fill out a questionnaire that elicits user characteristics related to the user's demo-, socio-, psycho-graphics and particular music tastes. If the user is already registered, this step can be bypassed and, following login, the system 100 can load the user's preferences and other user characteristic data 2004. The user can then be asked 2006 if they would like to create a new playlist or listening station based, for example, on a particular artist, genre, tempo, etc. If the user answers negatively, the selection component 106 can search the annotated record using user characteristics already in memory to select tracks 2007 the user is likely to enjoy. The system can then deliver 2008 those tracks through, for example, a streaming player interface like those discussed above.

Alternatively, if the user does elect to create or use a playlist or listening station, the user can be asked 2010 if they wish to create a new station or playlist. If the user wishes to create a new station or playlist, they can be presented with a search interface like those discussed herein to enter 2012 criteria for the creation of a playlist or listening station. If the listener prefers, an existing playlist or station can be selected 2014 instead. The selection component will then search the annotated record and select tracks based on the new or existing playlist or listening station characteristics, and deliver 2008 tracks to the user via, for example, a player interface.

The player interface can constantly monitor and record the user's interactions with the system 100. For example, if the user submits feedback 2016 regarding one or more digital music tracks delivered via the player interface, the feedback can be saved 2018 and incorporated into the user characteristics for the particular user and the annotated record for the digital music tracks. Even if the user does not provide feedback directly, the player interface can be configured to collect 2020 passive feedback indications from the user's interactions with the system and similarly incorporate those into the known user characteristics and the annotated record for the digital music tracks being delivered to the user. This collection process can proceed continuously until the user ends the listening session.

The delivery component 108 can also be configured to produce reporting notices regarding the digital music tracks being delivered to users through one or more interfaces. For example, the delivery component 108 can record 1704 every song streamed to a user and automatically produce and deliver 1706 periodic reports to PROs (e.g., SoundExchange) for royalty calculations, as well as other interested parties (e.g., artists or content providers can be sent reports of the number of plays of their tracks as well). Similarly, the delivery component 108 can create and deliver notifications regarding licensing of tracks selected in, for example, the sync licensing usage scenario described above. For example, the delivery component 108 can create and send a notification to each rights holder for a particular track after a user selects the track for licensing in a video sync project. In cases where the particular selected track has been pre-cleared for licensing, the notification can simply inform the rights holders of the license. However, if the selected track has not been pre-cleared (e.g., pricing terms remain to be negotiated, etc.), the notification can prompt each rights holder to respond to the license request to complete the licensing process. After all parties have approved a license, the delivery component 108 can deliver the selected track to a licensing user via download, online stream, or other means.

Further, delivery component 108 can be configured to provide automatic payment processing 1708 in response to the digital music tracks delivered to a user. For example, the delivery component 108 can be configured to automatically process 1708 royalty payments according to the reports 1706 created for submission to a PRO. Furthermore, direct payment processing from a user can be performed when the user wishes to specifically license a track, such as for media sync licensing.

User-facing interfaces can also provide one or more options for additional monetization in connection with a digital music track being delivered to a user. For example, a player interface can contain buttons or links to allow a user to permanently download the track for a fee (from the system 100 or from a third party content provider or distributor), as well as buttons or links to allow users to purchase tickets to artist concerts, related events, etc.

Any of the various interfaces provided by the system 100 described herein can be embodied in a variety of forms. For example, the interfaces can be implemented as web pages accessed by popular web browser software, or as native applications for desktop and/or mobile operating systems. Furthermore, the interfaces can also be provided as application programming interfaces (APIs) to allow other software programs or web pages to utilize the unique music collection, analysis, selection, and distribution processes of the present invention.

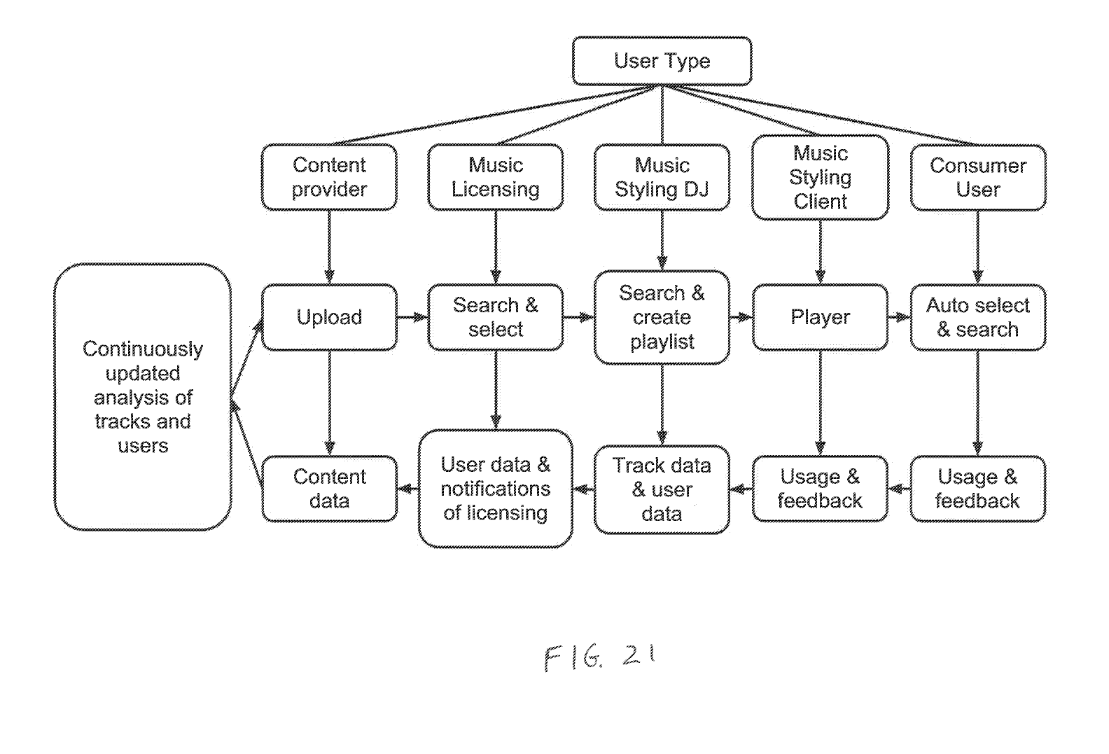

FIG. 21 illustrates an overall flow of data in the system 100 based on the type of user interacting with the system. For example, a content provider can interact with the system to upload content and submit identifying data for the content. A music licensing search user can utilize the music search and selection interfaces described herein to locate desired tracks that, in some cases, were uploaded by the content provider. A music styling user (e.g., a DJ) can utilize the search and playlist creation and organization interfaces described herein to create and style one or more playlists for a music styling client. A music styling client can utilize a player interface to listen to the playlists created by the music styling user and provide feedback on the selections. And a consumer user can utilize the automatic search and selection processes described herein to automatically have one or more digital music tracks that the user is likely to enjoy delivered via, for example, a streaming interface. The user can then provide feedback on the selections that have been delivered. All of the data entered into the system by all of the various users is continuously assimilated and analyzed by the system to create a richly descriptive and increasingly accurate record of the music and the users that enjoy it.

All papers and publications cited herein are hereby incorporated by reference in their entirety. One skilled in the art will appreciate further features and advantages of the invention based on the above-described embodiments. Accordingly, the invention is not to be limited by what has been particularly shown and described, except as indicated by the appended claims.

What is claimed is:

1. A method of selecting and delivering music to a user, comprising:
creating an annotated record of one or more digital music tracks by:
performing a waveform analysis on the one or more digital music tracks to determine characteristics of the one or more digital music tracks;
associating a plurality of global music factors with the one or more digital music tracks;
associating a plurality of population music factors with the one or more digital music tracks;
receiving, from a user, one or more user characteristics;
selecting one or more digital music tracks for delivery to the user by matching the one or more user characteristics against information contained in the annotated record of the one or more digital music tracks; and
delivering the one or more digital music tracks to the user.

2. The method of claim 1, further comprising receiving one or more digital music tracks via upload from a remote source and applying a rights clearance process to ensure that the one or more digital music tracks are approved for license and delivery to one or more users.

3. The method of claim 2, wherein the rights clearance process includes
receiving a listing of one or more rights holders and/or rights holder representatives in a digital music track;
electronically notifying each of the one or more rights holders and/or rights holder representatives that the digital music track has been submitted for delivery to one or more users;
electronically receiving approval from each of the one or more rights holders and/or rights holder representatives to deliver the digital music track to one or more users prior to delivering the digital music track to the user.

4. The method of claim 3, wherein each of the one or more rights holders and/or rights holder representatives are electronically notified via any of an email message and a notification on a website.

5. The method of claim 3, wherein approval from each of the one or more rights holders and/or rights holder representatives is electronically received via a website.

6. The method of claim 1, wherein the characteristics of the one or more digital music tracks determined by the waveform analysis include any of song tempo, song key, song era, song feel, song mood, vocal type, instrumentation, and playing style.

7. The method of claim 1, wherein the plurality of global music factors includes any of music sales information, listener demographic information, listener psychographic information, listener sociographic information, listener sentiment, listener location, song genre, song artist, song name, song date, song era, song artist label, song lyrics, and song length.

8. The method of claim 1, wherein the plurality of population music factors includes any of listener demographic information, listener psychographic information, listener sociographic information, song popularity, song popularity within specific social profiles and/or demographic groups and/or psychographic groups, listener habitation history, listener street, listener city, listener state, listener zip code, listener education, listener social profile, listener feedback rating, listener preference data, time of day for song performance, and type of event for song performance.

9. The method of claim 1, wherein the one or more user characteristics received from a user include any of song artist, similar artist, favorite artist, song name, similar song, song genre, place for song performance, type of event for song performance, time of day for song performance, song tempo, song mood, song feel, song and/or band geography, song instrument, song popularity, song era, song playlist, and playlist author.

10. The method of claim 1, wherein selecting one or more digital music tracks for delivery to the user includes receiving a listing of one or more digital music tracks selected by a disc jockey (DJ).

11. The method of claim 10, wherein selecting one or more digital music tracks for delivery to the user includes receiving, prior to receiving the listing of one or more digital music tracks selected by the DJ, one or more weighted search parameters based on any of the information in the annotated record of the digital music tracks and the one or more user characteristics received from the user.

12. The method of claim 1, wherein selecting one or more digital music tracks for delivery to the user includes executing an algorithm to automatically select the one or more digital music tracks based on a degree of matching between the user characteristics and the information in the annotated record.

13. The method of claim 12, wherein the algorithm assigns a weighting factor to each of the user characteristics utilized in selecting the one or more digital music tracks for delivery to the user.

14. The method of claim 1, further comprising receiving, from a user, one or more feedback indications based on the one or more digital music tracks delivered to the user; and
incorporating the one or more feedback indications into the plurality of population music factors and the one or more user characteristics.

15. The method of claim 1, further comprising associating any of the plurality of global music factors and population music factors of a first digital music track with a second digital music track;
wherein the second digital music track has no available global music factors or population music factors; and
wherein the waveform analysis indicates that the first digital music track and the second digital music track share a plurality of characteristics.

16. A system for selecting and delivering music to a user, comprising:
a digital data processor configured to create an annotated record of one or more digital music tracks by:
performing a song waveform analysis to determine characteristics of the one or more digital music tracks;
associating a plurality of global music factors with the one or more digital music tracks;
associating a plurality of population music factors with the one or more digital music tracks;
a user interface configured to receive, from a user, one or more user characteristics;
a digital data processor configured to select one or more digital music tracks for delivery to the user by matching the one or more user characteristics against information contained in the annotated record of the one or more digital music tracks.

17. The system of claim 16, further comprising a memory store configured to receive one or more digital music tracks from remote sources; and
a digital data processor configured to perform a rights clearance process to ensure that the one or more digital music tracks in the memory store are approved for delivery to one or more users.

18. The system of claim 17, wherein the digital data processor configured to perform a rights clearance process is further configured to:
receive a listing of one or more rights holders and/or rights holder representatives in a digital music track;
electronically notify each of the one or more rights holders and/or rights holder representatives that the digital music track has been submitted for delivery to one or more users;
electronically receive approval from each of the one or more rights holders to deliver the digital music track to one or more users prior to delivering the digital music track to the one or more users.

19. The system of claim 16, wherein the characteristics of the one or more digital music tracks determined by the waveform analysis include any of song tempo, song key, song mood, vocal type, and instruments used.

20. The system of claim 16, wherein the plurality of global music factors includes any of music sales information, listener demographic information, listener sentiment, listener location, song genre, song artist, song name, song date, song era, song artist label, song lyrics, and song length.

21. The system of claim 16, wherein the plurality of population music factors includes listener town, listener city, listener state, listener zip code, listener education, listener social profile, listener feedback rating, listener preference data, time of day for song performance, and type of event for song performance.

22. The system of claim 16, wherein the one or more user characteristics received from a user include song artist, similar artist, favorite artist, song name, similar song, song genre, place for song performance, type of event for song performance, time of day for song performance, song tempo, song mood, song instrument, song popularity, song era, song playlist, and playlist author.

23. The system of claim 16, wherein the digital data processor configured to select one or more digital music tracks from the memory store for delivery to the user further comprises a user interface configured to receive a listing of one or more digital music tracks from a disc jockey (DJ).

24. The system of claim 16, wherein the digital data processor configured to select one or more digital music tracks from the memory store for delivery to the user is configured to execute an algorithm to automatically select the one or more digital music tracks based on a degree of matching between the user characteristics and the information in the annotated record.

25. The system of claim 24, wherein the algorithm is configured to assign a weighting factor to each of the user characteristics utilized in selecting the one or more digital music tracks.

26. The system of claim 16, further comprising a user interface configured to deliver the one or more selected digital music tracks to the user via network streaming and to receive from the user one or more feedback indications based on the one or more digital music tracks.

27. A system for selecting and delivering music to a user, comprising:
a digital data processor configured to create an annotated record of one or more digital music tracks by:
performing a waveform analysis to determine characteristics of the one or more digital music tracks;
associating a plurality of global music factors with the one or more digital music tracks;
associating a plurality of population music factors with the one or more digital music tracks;
a first user interface configured to receive, from a user, one or more user characteristics;
a second user interface configured to provide one or more search mechanisms to allow a disc jockey (DJ) to search and select one or more digital music tracks based on any of the information in the annotated record of the one or more digital music tracks and the one or more user characteristics received from the user;
a third user interface configured to provide one or more ordering mechanisms to allow a DJ to create and organize one or more playlists containing the one or more digital music tracks selected in the second user interface based on any of the information in the annotated records of the one or more digital music tracks, the one or more user characteristics received from the user, and one or more music flow characteristics;
a fourth user interface configured to deliver the one or more digital music tracks selected by the DJ to the user and collect from the user one or more feedback indications based on the one or more digital music tracks delivered to the user.

28. The system of claim 27, further comprising a fifth user interface configured to receive one or more digital music tracks via network upload as well as electronic certifications of authorization from one or more rights holders and/or rights holder representatives to distribute the one or more digital music tracks to one or more users; and
a memory store in communication with the fifth user interface to store the one or more digital music tracks received via network upload.

29. The system of claim 27, wherein the one or more music flow characteristics include any of time of day, mood, vocals, genre, tempo, era, and instrumentation.

30. The system of claim 27, further comprising a digital data processor configured to automatically create a second playlist based on an first playlist created in the third user interface by selecting one or more digital music tracks having similar characteristics to the one or more digital music tracks in the first playlist;
wherein the second playlist and the first playlist do not contain the same digital music tracks.

31. The system of claim 27, further comprising a digital data processor configured to randomize a playlist created in the third user interface by:
grouping one or more digital music tracks of the playlist into a plurality of chunks comprising a desired number of tracks; and
randomly ordering the digital music tracks within each of the plurality of chunks;
wherein the order of the plurality of chunks is preserved; and
wherein the desired number of tracks is greater than one and less than the total number of tracks in the playlist.
